(19) United States
(12) Patent Application Publication
(10) Pub. No.: US 2026/0064025 A1
(43) Pub. Date: Mar. 5, 2026

(54) IMAGE FORMING APPARATUS

(71) Applicant: CANON KABUSHIKI KAISHA, Tokyo (JP)

(72) Inventors: Akinori Mitsumata, Tokyo (JP); Yuuji Obukuro, Saitama (JP); Isao Koishi, Kanagawa (JP); Yukio Kubo, Tokyo (JP); Shunsuke Hijikata, Kanagawa (JP); Naoki Hayashi, Kanagawa (JP); Yu Fukasawa, Tokyo (JP)

(21) Appl. No.: 19/294,479

(22) Filed: Aug. 8, 2025

(30) Foreign Application Priority Data
Aug. 27, 2024 (JP) 2024-146055
Aug. 27, 2024 (JP) 2024-146056

(51) Int. Cl. G03G 15/01; G03G 15/08

(52) U.S. Cl. CPC G03G 15/0121; G03G 15/011; G03G 15/0189; G03G 15/0875

(57) ABSTRACT

An image forming apparatus includes a first cartridge and a second cartridge. The first cartridge and the second cartridge are provided in one end portion of the image forming apparatus in a second direction perpendicular to a first direction. When one end portion and the other end portion of the image forming apparatus are first and second end portions, respectively, with respect to the first direction, the first cartridge is disposed so that one end portion thereof is on the first end portion side and the other end portion thereof is on the second end portion side, and is provided with a first discharge opening in either one end portion thereof. When the second cartridge is viewed in a third direction perpendicular to the first and second directions, the second cartridge is disposed so that at least a part thereof overlaps with the first cartridge.

### BACKGROUND

### Field of the Technology

The present disclosure relates to an image forming apparatus, such as a printer, a copying machine or a facsimile machine, using an electrophotographic type.

### Description of the Related Art

Conventionally, in the image forming apparatus using the electrophotographic type, a constitution in which by using a detachably mountable toner cartridge, toner is supplied to a developing container of a developing device provided in the image forming apparatus has been known.

In Japanese Laid-Open Patent Application (JP-A) No. 2023-7030, an image forming apparatus in which toner bottles are mounted to a plurality of supply containers provided correspondingly to a plurality of developing containers and thus toner can be supplied to the associated developing container without exchanging the developing container is disclosed. In the image forming apparatus disclosed in JP-A No. 2023-7030, the four photosensitive drums rotatable about rotational axes extending in a first direction are aligned and disposed in a second direction perpendicular to the first direction. Further, the four supply containers are aligned and disposed in the first direction in one end portion of the image forming apparatus with respect to the second direction.

Here, in an image forming apparatus, in general, it is desired in some cases that an accommodating volume of toner in a toner cartridge for black large in toner consumption amount compared with toner cartridges for other colors is increased. However, as in the above-described conventional constitution, in the constitution in which the toner cartridges for the four colors including black are aligned and disposed in the first direction, there is restriction on a shape in which the toner cartridge for black can be employed for realizing a large volume (capacity), so that a degree of freedom is small.

Further, there is a need to provide a toner conveying path from the toner cartridge to the developing container while avoiding an exposure device such as a laser scanner and an optical path from the exposure device to the photosensitive drum. For that reason, the following problem arises in the constitution, as the above-described conventional constitution, in which the toner cartridges for the four colors are aligned and disposed in the first direction. That is, as regards at least two toner cartridges disposed inside the image forming apparatus without being adjacent to an end portion of the image forming apparatus, there is a need that the toner conveying path from the toner cartridge to the developing container is once by-passed to an outside of the exposure device and the optical path thereof. For that reason, in some instances, the toner conveying path is complicated, so that the image forming apparatus is upsized and a toner accommodating volume (toner capacity) of the toner cartridge has to be reduced in order to ensure a space for the toner conveying path.

### SUMMARY

Therefore, the present disclosure is directed to realize a large volume (capacity) of a black toner cartridge while enabling effective utilization of a space by simplifying a toner conveying path from the toner cartridge toward a developing container.

According to an aspect of the present disclosure, there is provided an image forming apparatus comprising: (i) a main assembly including a first photosensitive drum rotatable about a first rotational axis extending in a first direction; a first developing unit including a first developing container for accommodating first toner supplied to the first photosensitive drum and a first developing roller for carrying the first toner accommodated in the first developing container, the first toner being black toner; a second photosensitive drum rotatable about a second rotational axis extending in the first direction; and a second developing unit including a second developing container for accommodating second toner supplied to the second photosensitive drum and different in color from the first toner and a second developing roller for carrying the second toner accommodated in the first developing container, the second developing unit is aligned with the first developing unit in a second direction perpendicular to the first direction; (ii) a first cartridge detachably mountable to the main assembly and accommodating the first toner, the first cartridge being provided with a first discharge opening for permitting discharge of the first toner toward the first developing container and being provided in one end portion of the image forming apparatus with respect to the second direction; and (iii) a second cartridge detachably mountable to the main assembly and accommodating the second toner, the second cartridge being provided with a second discharge opening for permitting discharge of the second toner toward the second developing container and being provided with in the one end portion of the image forming apparatus with respect to the second direction, wherein in a case where one end portion and the other end portion of the image forming apparatus with respect to the first direction are a first end portion and a second end portion, respectively, the first cartridge of which longitudinal direction is the first direction and is disposed with respect to the first direction so that one end portion thereof is positioned on a side of the first end portion of the image forming apparatus and so that the other end portion thereof is positioned on a side of the second end portion of the image forming apparatus, wherein the first discharge opening is provided in the end portion of the first cartridge on either one of the side of the first end portion and the side of the second end portion of the image forming apparatus, wherein the second cartridge is disposed with respect to the first direction in a position closer to the first end portion than to the second end portion of the image forming apparatus, wherein the second discharge opening is provided in an end portion of the second cartridge on a side of the first end portion of the image forming apparatus, and wherein in a case where the second cartridge is viewed in a third direction perpendicular to both the first direction and the second direction, the second cartridge is disposed so that at least a part thereof overlaps with the first cartridge.

Features of the present disclosure will become apparent from the following description of embodiments with reference to the attached drawings. The following description of embodiments are described by way of example.

### DESCRIPTION OF THE DRAWINGS

FIG. 1 is a schematic sectional view showing a schematic constitution of an image forming apparatus.

FIG. 2 is a schematic perspective view of the image forming apparatus.

FIG. 3 is a perspective view of an outer appearance of the image forming apparatus in a state in which a front door is open.

FIG. 4 is a perspective view of the outer appearance of the image forming apparatus in a state in which a cartridge is demounted.

FIG. 5 is a front view of an image forming unit in an embodiment 1.

FIG. 6 is a perspective view of the image forming unit.

FIG. 7 is a perspective view of the image forming unit from which the cartridge is demounted.

FIG. 8 is a plan (top) view of the image forming unit and a laser scanner.

FIG. 9 is a plan view of the image forming unit in which optical paths of laser light are shown.

FIG. 10 is a side view of the image forming unit and the laser scanner.

Parts (a) and (b) of FIG. 11 are schematic views for illustrating a positional relationship between a supply pipe, a discharge opening, and an optical path of laser light.

Parts (a) and (b) of FIG. 12 are a perspective view and a front view, respectively, of the image forming unit, for illustrating a conveying device.

Parts (a) and (b) of FIG. 13 are a front view and a perspective view, respectively, of an image forming unit in an embodiment 2.

FIG. 14 is a schematic sectional view showing a schematic constitution of an image forming apparatus.

FIG. 15 is a perspective view of an outer appearance of the image forming apparatus.

FIG. 16 is a perspective view of the outer appearance of the image forming apparatus in a state in which a front door is open.

FIG. 17 is a perspective view of the outer appearance of the image forming apparatus in a state in which a cartridge is demounted.

FIG. 18 is a front view of an image forming unit in an embodiment 3.

FIG. 19 is a perspective view of the image forming unit.

FIG. 20 is a perspective view of the image forming unit from which a cartridge is demounted.

FIG. 21 is a plan view of the image forming unit and a laser scanner.

FIG. 22 is a plan view of the image forming unit in which optical paths are shown.

FIG. 23 is a side view of the image forming unit and the laser scanner.

Parts (a) and (b) of FIG. 24 are schematic views for illustrating a positional relationship between a supply pipe, a discharge opening, and an optical path of laser light.

Parts (a) and (b) of FIG. 25 are a perspective view and a front view, respectively, of the image forming unit, for illustrating a conveying device.

Parts (a) and (b) of FIG. 26 are a front view and a perspective view, respectively of an image forming unit in an embodiment 4.

Parts (a) and (b) of FIG. 27 are a front view and a perspective view, respectively, of an image forming unit in an embodiment 5.

Parts (a) and (b) of FIG. 28 are a front view and a perspective view, respectively, of an image forming unit in an embodiment 6.

Parts (a) and (b) of FIG. 29 are a front view and a perspective view, respectively, of an image forming unit in an embodiment 7.

Parts (a) and (b) of FIG. 30 are a front view and a perspective view, respectively, of an image forming unit in an embodiment 8.

### DESCRIPTION OF THE EMBODIMENTS

In the following, an image forming apparatus according to the present disclosure will be described specifically with reference to the drawings.

### Embodiment 1

### <Constitution of Image Forming Apparatus>

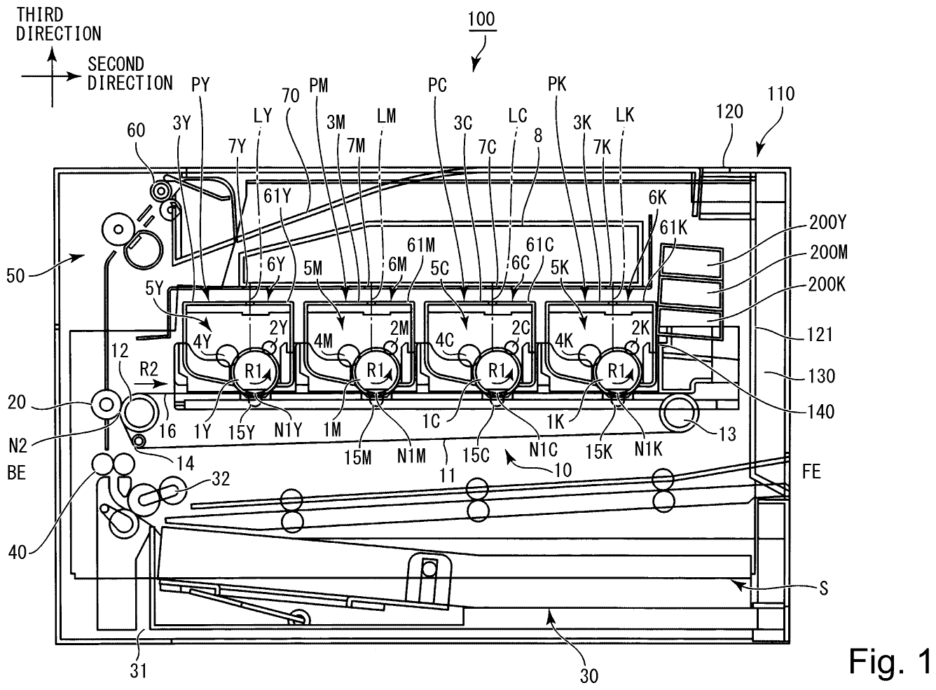

FIG. 1 is a schematic sectional view showing a schematic constitution of an image forming apparatus 100 of an embodiment 1 (shows a cross section substantially perpendicular to a rotational axis direction of a photosensitive drum 1 described later). The image forming apparatus 100 is a tandem-type full-color laser printer employing an intermediary transfer type in which a full-color image is capable of being formed on a sheet-like recording material S by using an image forming process (electrophotographic process) of an electrophotographic type.

The image forming apparatus 100 includes, in a main assembly casing 120, four process units PY, PM, PC, and PK as a plurality of process units. The four process units PY, PM, PC, and PK form toner images (toner pictures, developer images) of colors of yellow (Y), magenta (M), cyan (C), and black (K), respectively. Incidentally, constitutions of the four-process units PY, PM, PC, and PK are similar to each other except that colors of toner accommodated inside developing containers 3 of developing units 5 described later are different from each other. As regards elements, having the same or corresponding functions or constitutions, provided for the respective colors will be collectively described in some instances by omitting suffixes of reference numerals or symbols each showing the element for the associated color.

The four process units PY, PM, PC, and PK are aligned and disposed along (in this embodiment, substantially parallel to) a movement direction of a primary transfer surface 16 of an intermediary transfer belt 11 described later. Specifically, the photosensitive drums 1 and developing units 5 which constitute the four process units PY, PM, PC, and PK, respectively, are aligned and disposed along (in this embodiment substantially parallel to) the movement direction of the primary transfer surface 16 of the intermediary transfer belt 11.

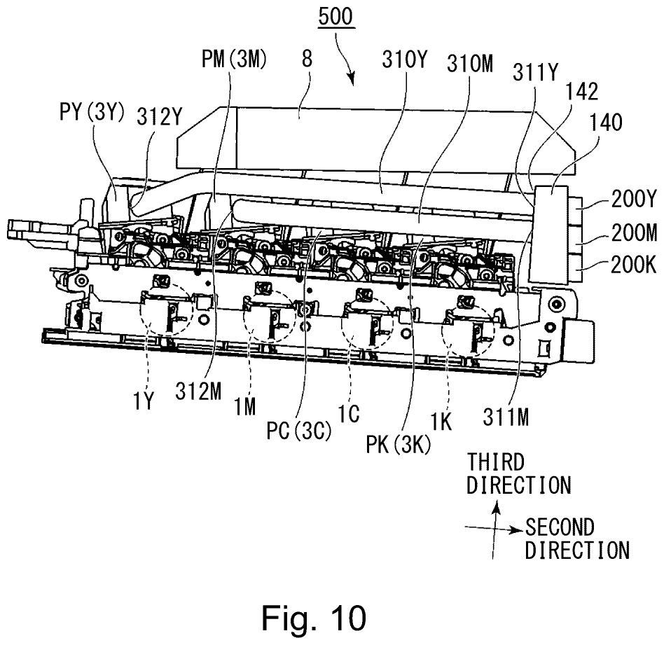

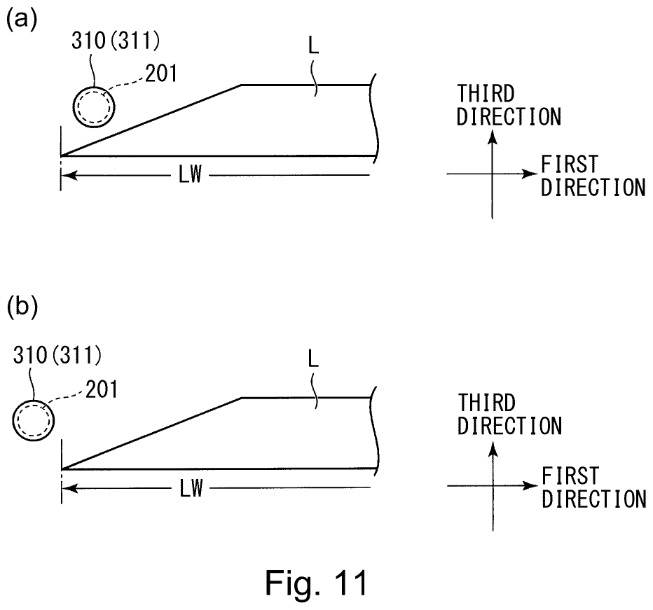

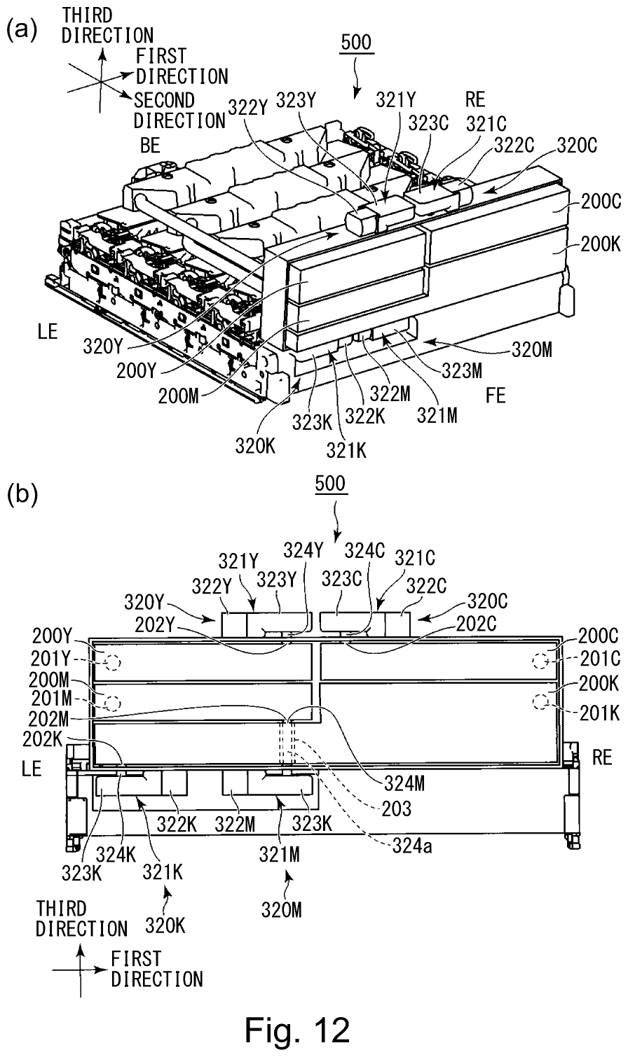

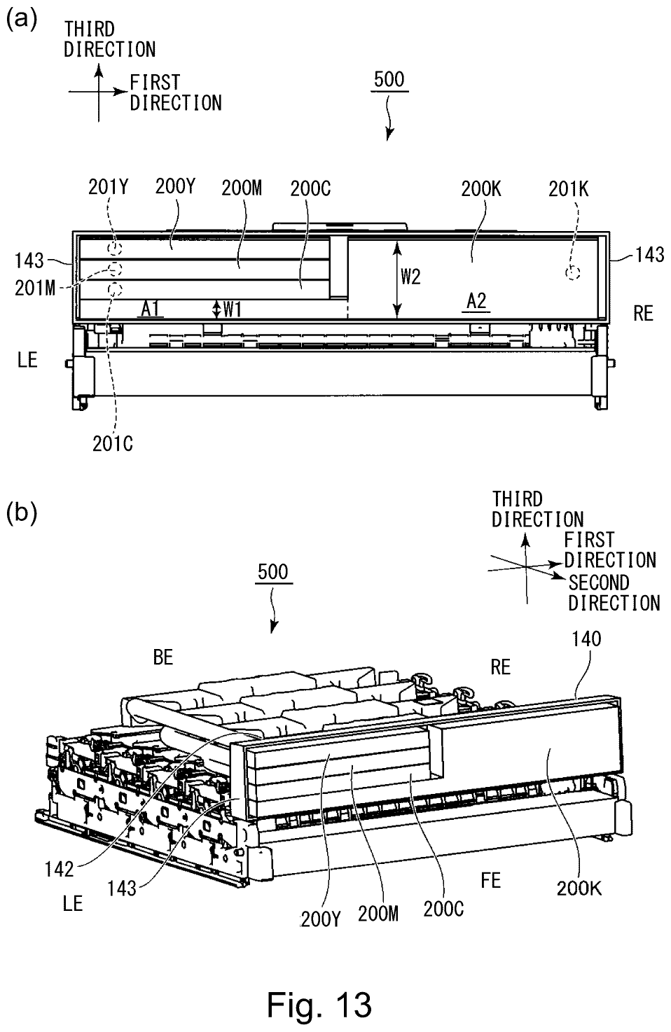

Here, as regards the image forming apparatus 100 and elements thereof, the rotational axis direction of the photosensitive drum 1 (a longitudinal direction of the process unit P, the developing unit 5, a drum unit 6) is referred to as a “first direction (X direction)”. that is, the photosensitive drum 1 is rotatable bout a rotational axis extending in the first direction. Further, as regards the image forming apparatus 100 and elements thereof, a direction perpendicular to the first direction is referred to as a “second direction (Y direction)”. The four process cartridges PY, PM, PC, and PK are aligned and disposed in the second direction. That is, an alignment direction of the four process units PY, PM, PC, and PK (specifically, the photosensitive drums 1 and the developing units 5) is the second direction. Further, as regards the image forming apparatus 100 and the elements thereof, a direction perpendicular to both the first direction and the second direction is referred to as a “third direction (Z direction)”. Further, as regards the image forming apparatus 100 and the elements thereof, up (upper) and down (lower) refer to those with respect to a gravitational direction (vertical direction), but do not mean only immediately on (above) and immediately under (below), respectively, and include an upper side and a lower side than a horizontal surface (plane) passing through a noticed position or a noticed element. The image forming apparatus 100 is disposed so that the first direction becomes substantially parallel to a horizontal direction and so that the second direction crosses the gravitational direction, and is used for image formation. In FIG. 1, the image forming apparatus 100 is drawn so that the second direction becomes substantially parallel to the horizontal direction, but as shown in FIG. 10, the second direction may also have an angle with respect to the horizontal direction. Further, as regards the image forming apparatus 100, a right side in FIG. 1 is a “front surface (FE)” side, a left side in FIG. 1 is a “rear (back) surface (BE)” side, a left side as viewed from the front surface side is a “left side surface (LE)” side, and a right side as viewed from the front surface side is a “right side surface (RE)” side. In this embodiment, the four process units PY, PM, PC, and PK are arranged in this order from the rear (back) surface side toward the front surface side along the second direction.

The process unit P includes electrophotographic process elements. To the process unit P, a rotational driving force of a rotatable member (the photosensitive drum 1, a developing roller 4, or the like described later) is transmitted from a drive output portion (not shown) provided in the main assembly casing 120. Further, to the process unit P, a bias voltage (a charging bias, a developing bias, or the like described later) is supplied from a bias applying portion (not shown) provided in the main assembly casing 120.

The process unit P includes the drum unit 6 (6Y, 6M, 6C, 6K). The drum unit 6 (6Y, 6M, 6C, 6K) includes the photosensitive drum 1 (1Y, 1M, 1C, 1K) and a charging roller 2 (2Y, 2M, 2C, 2K) which is a roller-type charging member as a charging means for electrically charging the photosensitive drum 1. The charging roller 2 constitutes process means acting on the photosensitive drum 1. The photosensitive drum 1 is rotatable about the rotational axis extending in the first direction. The drum unit 6 is constituted by that the photosensitive drum 1, the charging roller 2, and the like are held by a drum unit frame 61.

Further, the process unit P includes the developing unit (developing device) 5 (5Y, 5M, 5C, 5K) as a developing means for developing an electrostatic latent image formed on the photosensitive drum 1. The developing unit 5 constitutes the process means acting on the photosensitive drum 1. The developing unit 5 includes a developing container 3 (3Y, 3M, 3C, 3K) for accommodating toner as a developer and the developing roller 4 (4Y, 4M, 4C, 4K) as a developer carrying member (developing member). The developing containers 3Y, 3M, 3C, and 3K accommodate yellow toner, magenta toner, cyan toner, and black toner, respectively. The developing roller 4 carries and conveys the toner accommodated in the developing container 3 and supplies the toner to a surface of the photosensitive drum 1. In this embodiment, the toner as the developer is a non-magnetic one-component developer. Further, in this embodiment, the developing unit 5 causes the toner, charged to the same polarity as a charging polarity (negative polarity in this embodiment) of the photosensitive drum 1, to be deposited on an exposed portion on the photosensitive drum 1 lowered in absolute value of a potential by being exposed to light after being uniformly charged. In this embodiment, a normal charge polarity of the toner which is a principal charge polarity of the toner during development is the negative polarity. The developing unit 5 is constituted by that the developing roller 4 or the like is held by a frame constituting the developing container 3.

In the main assembly casing 120, above the process unit P, a laser scanner unit (exposure unit, exposure device) 8 as an exposure means for forming the electrostatic latent image (electrostatic image) on the photosensitive drum 1 by exposing the photosensitive drum 1 to light is provided. The laser scanner unit 8 outputs laser light corresponding to image signals (image information) of the colors of yellow, magenta, cyan, and black and irradiates the photosensitive drums 1Y, 1M, 1C, and 1K, respectively. Optical paths of the laser light from the laser scanner unit 8 toward the photosensitive drums 1Y, 1M, 1C, and 1K are referred to as optical sheets LY, LM, LC, and LK, respectively. The laser light passes through an exposure window 7 (7Y, 7M, 7C, 7K) of the laser scanner unit 8, so that the surface of the photosensitive drum 1 is subjected to scanning exposure to the laser light. Incidentally, the exposure means is not limited to the laser scanner unit 8, but may also be an LED exposure unit, for example.

In the main assembly casing 120, below the process unit P (on a side opposite from the laser scanner unit 8 while sandwiching between the laser scanner unit 8 and an intermediary transfer belt unit 10 in a third direction), the intermediary transfer belt unit 10 as a transfer device is provided. The intermediary transfer belt unit 10 includes an intermediary transfer belt 11 as an intermediary transfer member, a driving roller 12, a tension roller 13, and an assisting roller 14 which are as a plurality of stretching surfaces, and primary transfer rollers 15Y, 15M, 15C, and 15K which are as primary transfer means. The intermediary transfer belt 11 constituted by a flexible endless belt is extended around the driving roller 12, the tension roller 13, and the assisting roller 14, and is stretched under predetermined tension. Lower surfaces of the photosensitive drums 1Y, 1M, 1C, and 1K contact a primary transfer surface 16 which is an upper surface of the intermediary transfer belt 11. The primary transfer surface 16 is a surface of the intermediary transfer belt 11 onto which a toner image is transferred from the photosensitive drum 1 and is constituted by a surface of the intermediary transfer belt 11 stretched by the driving roller 12 and the tension roller 13. On an inner peripheral surface side of the intermediary transfer belt 11, in positions opposing the photosensitive drums 1Y, 1M, 1C, and 1K through the intermediary transfer belt 11, the primary transfer rollers 15Y, 15M, 15C, and 15K which are roller-type primary transfer members as primary transfer means are disposed, respectively.

The primary transfer roller 15 is pressed toward the photosensitive drum 1 through the intermediary transfer belt 11 and forms a primary transfer portion N1 (N1Y, N1M, N1C, N1K) which is a contact portion between the photosensitive drum 1 and the intermediary transfer belt 11. Further, on an outer peripheral surface side of the intermediary transfer belt 11, in a position opposing the driving roller 12 through the intermediary transfer belt 11, a secondary transfer roller 20 as a secondary transfer means is provided. The secondary transfer roller 20 is pressed toward the driving roller 12 through the intermediary transfer belt 11 and forms a secondary transfer portion which is a contact portion between the intermediary transfer belt and the secondary transfer roller 20.

In the main assembly casing 120, below the intermediary transfer belt 11, a feeding unit 30 as a feeding means is provided. The feeding unit 30 includes a feeding tray 31 as a recording material accommodating portion for accommodating a recording material (recording medium, transfer material, sheet) S such as paper or a plastic sheet, and a feeding roller 32 as a feeding member for picking up and conveying the recording material S from the feeding tray 31. Further, in the main assembly casing 120, a registration roller pair 40 as a conveying member is provided on a side downstream of the feeding unit 30 and upstream of the secondary transfer portion N2 with respect to a conveying direction of the recording material S.

Further, in the main assembly casing 120, a fixing unit (fixing device) 50 as a fixing means for fixing the toner image on the recording material S is provided on a side downstream of the secondary transfer portion N2 (above the process unit P) with respect to the conveying direction of the recording material S. Further, in the main assembly casing 120, a discharging roller 60 for discharging the recording material S, on which the toner image is formed, to an outside of the main assembly casing 120 is provided on a side downstream of the fixing unit 50 (above the fixing unit 50) with respect to the conveying direction of the recording material S. Further, outside (on an upper portion of) the main assembly casing 120, a discharge tray 70 on which the recording material S discharged from the inside of the main assembly casing 120 is stacked is provided.

Here, in this embodiment, the discharging roller 60 discharges the recording material S is a direction from the rear surface side toward the front surface side along the second direction. That is, in this embodiment, a downstream side in a discharging direction of the recording material S by the discharging roller 60 is a front surface side (front side) of the image forming apparatus 100, and an upstream side in the discharging direction of the recording material S is a rear surface side (rear side) of the image forming apparatus 100.

### <Image Forming Operation>

Next, an image forming operation of the image forming apparatus 100 will be described by taking an image forming operation during full-color image formation as an example.

During the image formation, the photosensitive drum 1 is rotationally driven in an arrow R1 direction (counterclockwise direction) in FIG. 1 at a predetermined rotational speed (peripheral speed). Further, the driving roller 12 is rotationally driven, so that the intermediary transfer belt 11 is rotated (circulated and moved) in an arrow R2 direction (clockwise direction) in FIG. 1 at a rotational speed corresponding to the rotational speed of the photosensitive drum 1. In a contact portion between the photosensitive drum 1 and the intermediary transfer belt 11, the surface of the photosensitive drum 1 and the surface of the intermediary transfer belt 11 more in a forward direction. The stretching rollers other than the driving roller 12, and the primary transfer roller 15 are rotated with the rotation of the intermediary transfer belt 11.

Further, drive of the laser scanner unit 8 is started. In synchronism with the start of the drive, the surface of the photosensitive drum 1 is uniformly charged to a predetermined polarity (negative polarity in this embodiment) and a predetermined potential by the charging roller 2. During the charging, to the charging roller 2, a charging voltage (charging bias) of the same polarity as the charge polarity of the photosensitive drum 1 is applied. The charged surface of the photosensitive drum 1 is subjected to scanning exposure to laser light depending on an image signal of a color corresponding to each of the process units P by the laser scanner unit 8, so that the electrostatic latent image corresponding to the associated color image signal is formed on the photosensitive drum 1.

The electrostatic latent image formed on the photosensitive drum 1 is developed (visualized) by being supplied with the toner by the developing unit 5. The developing unit 5 supplies the toner to the surface of the photosensitive drum 1 by the developing roller 4 rotationally driven in the clockwise direction in FIG. 1 at a predetermined rotational speed. During development, to the developing roller 4, a developing voltage (developing bias) of the same polarity as the charge polarity of the photosensitive drum 1 is applied. By the above-described process, on the photosensitive drums 1Y, 1M, 1C, and 1K, the yellow toner, the magenta toner, the cyan toner, and the black toner are formed, respectively. The toner images formed on the photosensitive drums 1Y, 1M, 1C, and 1K are successively transferred (primarily transferred) superposedly onto the rotating intermediary transfer belt 11 in the same image forming region in the primary transfer portions N1Y, N1M, N1C, and N1K, respectively. During the primary transfer, to the primary transfer roller 15, a primary transfer voltage (primary transfer bias) of n opposite polarity (positive polarity in this embodiment) to the normal charge polarity of the toner is applied.

Thus, on the intermediary transfer belt 11, the toner images of the four colors of yellow, magenta, cyan, and black constituting the full-color image are formed. On the other hand, at a predetermined control timing, recording materials S are separated and fed one by one from the feeding tray 31 by the feeding roller 32. This recording material S is guided toward the secondary transfer portion N2 at a predetermined control timing by the registration roller pair 40. Further, in a process in which this recording material S is nipped and conveyed in the secondary transfer portion N2 by the intermediary transfer belt 11 and the secondary transfer roller 20, the toner images on the intermediary transfer belt 11 are transferred (secondary transferred) onto the recording material S. During the secondary transfer, to the secondary transfer roller 20, a secondary transfer voltage (secondary transfer bias) of the opposite polarity (positive polarity in this embodiment) to the normal charge polarity of the toner is applied. The driving roller 12 is electrically grounded (connected to the ground potential).

Further, the secondary transfer roller 20 is rotated with the rotation of the intermediary transfer belt 11.

The recording material S on which the toner image is transferred is heated and pressed by the fixing unit 50, so that the toner image is fixed (melted, stuck) on the recording material S. The recording material S on which the toner image is fixed is discharged (outputted) toward the discharge tray 70 by the discharging roller 60.

Incidentally, the image forming apparatus 100 is also capable of forming a monochromatic (single-color) image (such as a black (monochromatic) image) or a multi-color image by using a desired single or a desired plurality of process units P.

Further, the process unit P may also include a cleaning means for removing residual toner from the surface of the photosensitive drum 1. As the cleaning means, a cleaning device for accommodating a cleaning container by scraping off the toner from the surface of the rotating photosensitive drum 1 with a cleaning blade as a cleaning member.

Further, the image forming apparatus 100 may also include a cleaning means for removing residual toner from the surface of the intermediary transfer belt 11. Also, as this cleaning means, a cleaning device similar to the above-described cleaning provided can be used.

### <Outline of Toner Supply>

Next, an outline of toner supply toward the developing container 3 of the developing device 5 in this embodiment will be described.

A front surface side end portion which is one end portion of the image forming apparatus 100 with respect to the second direction is provided with a main assembly opening 121 which is an opening of the main assembly casing 120. Further, the main assembly casing 120 is provided with a front door 130 as an openable/closable member for opening and closing the main assembly opening 121. With respect to the second direction, between the process unit P and the main assembly opening 121, a cartridge holder 140 is provided. To this cartridge holder 140, toner cartridges (herein, simply referred also to as “cartridges”) 200Y, 200M, 200C, and 200K which are toner containers for supply and for the colors of yellow, magenta, cyan, and black are detachably mounted. By this, the cartridges 200Y, 200M, 200C, and 200K are detachably mounted to an apparatus main assembly 110 of the image forming apparatus 100. The cartridges 200Y, 200M, 200C, and 200K contain the yellow toner, the magenta toner, the cyan toner, and the black toner, respectively, therein. Further, to the developing containers 3Y, 3M, 3C, and 3K of the developing devices 5Y, 5M, 5C, and 5K, the yellow toner, the magenta toner, the cyan toner, and the black toner are supplied from the cartridges 200Y, 200M, 200C, and 200K, respectively. Herein, a portion obtained by excluding the cartridges 200Y, 200M, 200C, and 200K from the image forming apparatus 100 is referred to as the “apparatus main assembly 110”.

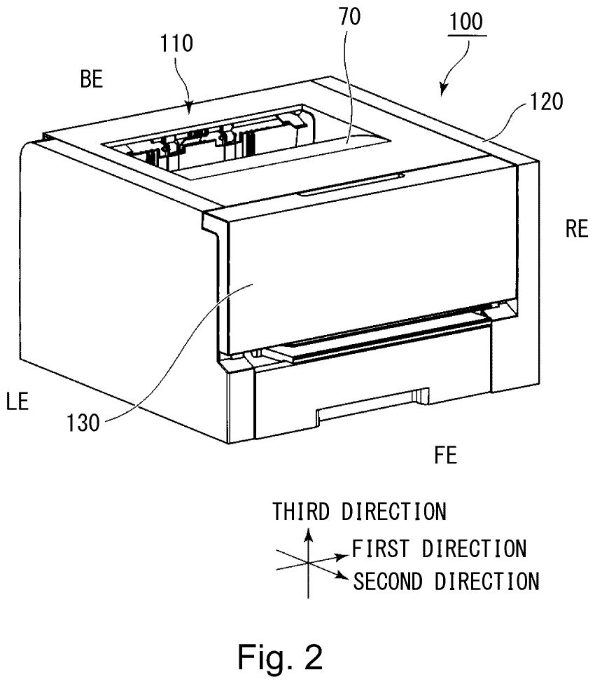

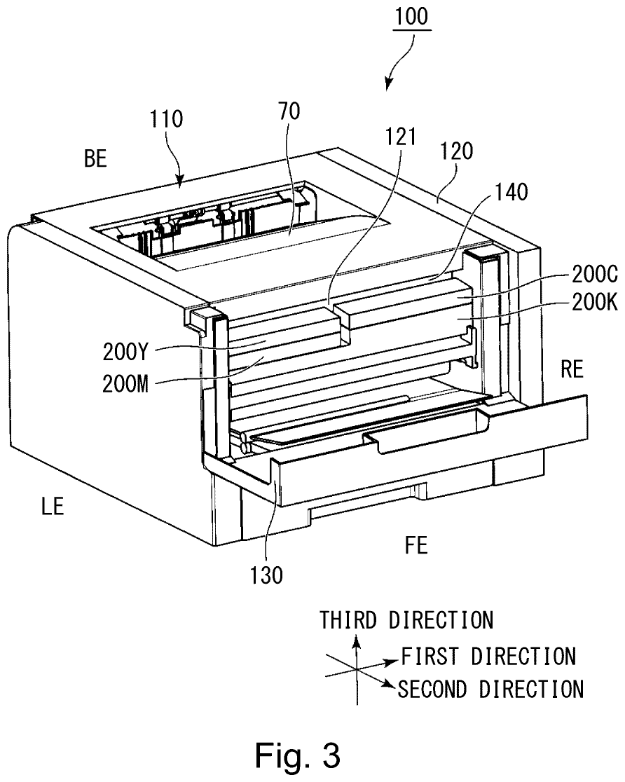

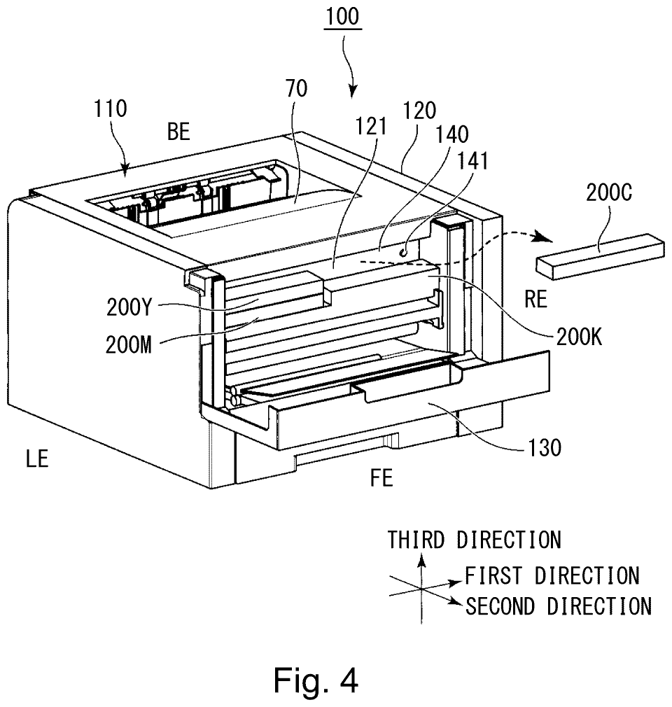

FIG. 2 is a perspective view of the image forming apparatus 100 in a state in which the front door 130 is closed. FIG. 3 is a perspective view of the image forming apparatus 100 in a state in which the front door 130 is opened. FIG. 4 is a perspective view of the image forming apparatus 100 in a state in which the cartridge 200C for cyan is demounted from the cartridge holder 140 in a state in which the front door 130 is opened.

The front door 130 is constituted so as to be movable between a closed position (FIG. 2) where the main assembly opening 121 is closed and an open position (FIGS. 3 and 4) where the main assembly opening 121 is open. In this embodiment, the front door 130 is constituted so s to be movable between the closed position and the open position by being rotated about a rotational axis positioned in a lower end portion thereof and substantially parallel to the first direction. As shown in FIGS. 3 and 4, an operator opens the front door 130 and is capable of accessing the cartridges 200. Thus, the cartridges 200 are detachably mounted to the apparatus main assembly 110 in the front surface side end portion which is one end portion of the image forming apparatus 100 with respect to the second direction. In other words, the cartridges 200 are provided in an end portion of the image forming apparatus 100 on a downstream side with respect to a discharging direction of the recording material S by the discharging roller 60.

As shown in FIG. 4, the cartridges 200 are constituted so as to be detachably mountable to the cartridge holder 140 by being moved along the second direction. By this, the operator is capable of supplying the toner to the process unit P without demounting the process unit P from the apparatus main assembly 110. Further, the cartridges 200 are disposed in the front surface side end portion of the image forming apparatus 100, whereby the operator is capable of accessing the cartridges 200 from the front surface side of the image forming apparatus 100 similarly as in the case of collection of the recording material S discharged on the discharge tray 70.

Further, as shown in FIG. 4, the image forming apparatus 100 is provided with the cartridge holder 140 in the front surface side end portion thereof, and therefore, even after the cartridge 200 is demounted, the process unit P is substantially prevented from being exposed to the outside of the image forming apparatus 100. The cartridge 200 is accommodated in the apparatus main assembly 110 in a state in which the front door 130 is closed.

Incidentally, the cartridge holder 140 may be provided with a holding means for detachably holding the cartridges 200. As the holding means, it is possible to use an arbitrary means such as a constitution in which the cartridge 200 is held by press-fitting at least a part thereof into a holding portion or a constitution in which at least a part of the cartridge 200 is locked by an elastically deformable locking portion, for example.

### <Arrangement of Toner Cartridges>

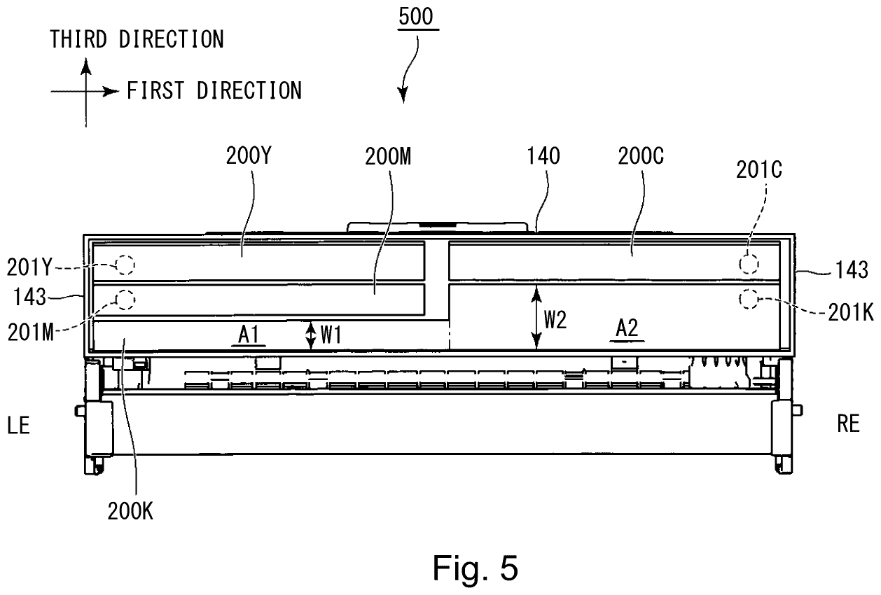

Next, with reference to FIGS. 3 to 5, arrangement of the cartridges 200Y, 200M, 200C, and 200K will be described. FIG. 5 is a front view of the cartridges 200Y, 200M, 200C, and 200K mounted to the cartridge holder 140 (an image forming unit 500 described later) as viewed in the second direction from the front surface side.

The image forming apparatus 100 includes the cartridges 200, 200M, 200C, and 200K detachably mountable to the apparatus main assembly 110. The cartridges 200Y, 200M, 200C, and 200K are disposed in the front surface side end portion of the image forming apparatus 100 with respect to the second direction.

Further, as regards each of the cartridges 200Y, 200M, 200C, and 200K, at least one end portion thereof with respect to the first direction is disposed adjacently to an end portion of the image forming apparatus 100 with respect to the first direction.

Of these cartridges, the cartridge 200K for black is disposed so that opposite end portions thereof with respect to the first direction are disposed adjacently to the associated end portions of the image forming apparatus 100 with respect to the first direction. In other words, the cartridge 200K for black extends in the first direction from a position adjacent to one end portion of the image forming apparatus 100 to a position adjacent to the other end portion of the image forming apparatus 100. Further, in this embodiment, the cartridge 200K for black is disposed so that at least a part thereof containers with each of the cartridges 200 for other colors with respect to the third direction.

Further, in the case where the cartridge 200K for black is viewed in the second direction from the front surface side, the cartridge 200K has an L-character shape. That is, a longitudinal direction of the cartridge 200K for black is the first direction, and the cartridge 200K for black includes a first region (area) A1 and a second region (area) A2 with respect to the first direction. The first region A1 is a region in which a width thereof in the third direction is a first width W1. Further, the second region A2 is a region in which a width thereof in the third direction is a second width W2 wider than the first width W1. The first region A1 is disposed on a side of a left side surface side end portion (first end portion) of the image forming apparatus 100 with respect to the first direction. Further, the second region A2 is disposed on a side of a right side surface side end portion (second end portion) of the image forming apparatus 100 with respect to the first direction. The first width W1 is substantially the same as a width of each of the cartridges 200Y, 200M, and 200C for yellow, magenta, and cyan, respectively, in the third direction. The second width W2 is substantially two times the width of each of the cartridges 200Y, 200M, and 200C for yellow, magenta, and cyan, respectively, in the third direction.

On the other hand, each of the cartridges 200Y, 200M, and 200C for yellow, magenta, and cyan, respectively, is disposed so that one end portion thereof with respect to the first direction is adjacent to the associated end portion of the image forming apparatus 100 with respect to the first direction. In this embodiment, the cartridges 200Y for yellow, 200M for magenta, and 200C for cyan have substantially the same outer configuration (substantially rectangular parallelopiped shape long in the first direction). The cartridge 200 for yellow and the cartridge 200M for magenta are shifted to and disposed in the left side surface side end portion of the image forming apparatus 100 with respect to the first direction. That is, the cartridge 200Y for yellow and the cartridge 200M for magenta are disposed in positions closer to the left side surface side end portion (first end portion) than to a right side surface side end portion (second end portion) of the image forming apparatus 100 with respect to the first direction. Further, the cartridge 200C for cyan is shifted to and disposed in the right side surface side end portion of the image forming apparatus 100 with respect to the first direction. That is, the cartridge 200C for cyan is disposed in a position closer to the right side surface side end portion (second end portion) than to the left side surface side end portion (first end portion) of the image forming apparatus 100 with respect to the first direction.

Further, on the left side surface side, the cartridge 200Y for yellow, the cartridge 200M for magenta, and the cartridge 200K for black (first region A1) are disposed so as to overlap with each other with respect to the third direction. Further, on the right side surface side, the cartridge 200C for cyan and the cartridge 200K for black (second region A2) are disposed so as to overlap with each other with respect to the third direction. Here, disposition (arrangement) such that one cartridge 200 (or a predetermined region thereof) and another cartridge 200 (or a predetermined region thereof) are disposed so as to overlap with each other with respect to the third direction specifically refers to the following disposition (arrangement). That is, in the case where these cartridges are viewed in the third direction, at least a part of the one cartridge 200 (or the predetermined region thereof) and at least a part of the another cartridge 200 (or the predetermined region thereof) overlap with each other. The cartridge 200Y for yellow, the cartridge 200M for magenta, and the cartridge 200K for black (first region A1) are arranged in this order from an upper side toward a lower side along the third direction, and are disposed adjacently to each other. Further, the cartridge 200C for cyan and the cartridge 200K for black (second region A2) are arranged in this order from the upper side toward the lower side along the third direction, and are disposed adjacently to each other.

Further, the cartridge 200Y for yellow and the cartridge 200C for cyan are disposed so as to overlap with each other with respect to the first direction. Here, disposition (arrangement) such that one cartridge 200 (or a predetermined region thereof) and another cartridge 200 (or a predetermined region thereof) are disposed so as to overlap with each other with respect to the first direction specifically refers to the following disposition (arrangement). That is, in the case where these cartridges are viewed in the first direction, at least a part of the one cartridge 200 (or the predetermined region thereof) and at least a part of the another cartridge 200 (or the predetermined region thereof) overlap with each other. The cartridge 200Y for yellow and the cartridge 200C for cyan are arranged in the first direction, and are disposed adjacently to each other. Further, the cartridge 200M for magenta and the cartridge 200K for black (second region A2) are disposed so as to convey with each other with respect to the first direction. The cartridge 200M for magenta and the cartridge 200K for black (second region A2) are arranged in the first direction, and are disposed adjacently to each other.

Particularly, in this embodiment, the cartridge 200Y for yellow and the cartridge 200M for magenta have substantially the same outer configuration. Further, in this embodiment, as viewed in the third direction, the first region A1 of the cartridge 200K for black, and the cartridges 200Y for yellow and 200M for magenta have substantially the same configuration. Further, the cartridge 200Y for yellow, the cartridge 200M for magenta, and the first region A1 of the cartridge 200K for black are aligned and disposed along the third direction (substantially parallel to each other in this embodiment). In this embodiment, as viewed in the third direction, the cartridge 200Y for yellow, the cartridge 200M for magenta, and the first region A1 of the cartridge 200K for black substantially entirely overlap with each other. Further, in this embodiment, as viewed in the third direction, the second region A2 of the cartridge 200K for black and the cartridge 200C for cyan has substantially the same configuration. Further, the cartridge 200C for cyan and the second region A2 of the cartridge 200K for black are aligned and disposed along the third direction (substantially parallel to each other in this embodiment). In this embodiment, as viewed in the third direction, the cartridge 200C for cyan and the second region A2 of the cartridge 200K for black substantially entirety overlap with each other. Further, the cartridge 200Y for yellow and the cartridge 200C for cyan are aligned and disposed along the first direction (substantially parallel to each other in this embodiment). In this embodiment, as viewed in the first direction, the cartridge 200Y for yellow and the cartridge 200C for cyan substantially entirety overlap with each other.

Further, the cartridges 200Y, 200M, 200C, and 200K are provided with discharge openings 201Y, 201M, 201C, and 201K, respectively, each for permitting discharge of the toner. The discharge openings 201 are provided in end portions of the cartridges 200, with respect to the first direction, adjacent to the associated end portion of the image forming apparatus 100 with respect to the first direction (FIG. 5). Details of arrangement of the discharge openings 201 will be described later.

Incidentally, in this embodiment, the cartridges 200Y, 200M, 200C, and 200K for the colors of yellow, magenta, cyan, and black, respectively are arranged in color as described above, but as regards yellow, magenta, and cyan, color arrangement different from the color arrangement in this embodiment may also be employed. Further, arrangement of the colors of the cartridges 200 overlapping with each other with respect to the third direction is such that the number of the colors is three (colors) on the left side surface side and two (colors) on the right side surface side, but may also be two (colors) on the left side surface side and three (colors) on the right side surface side.

### <Toner Conveying Path>

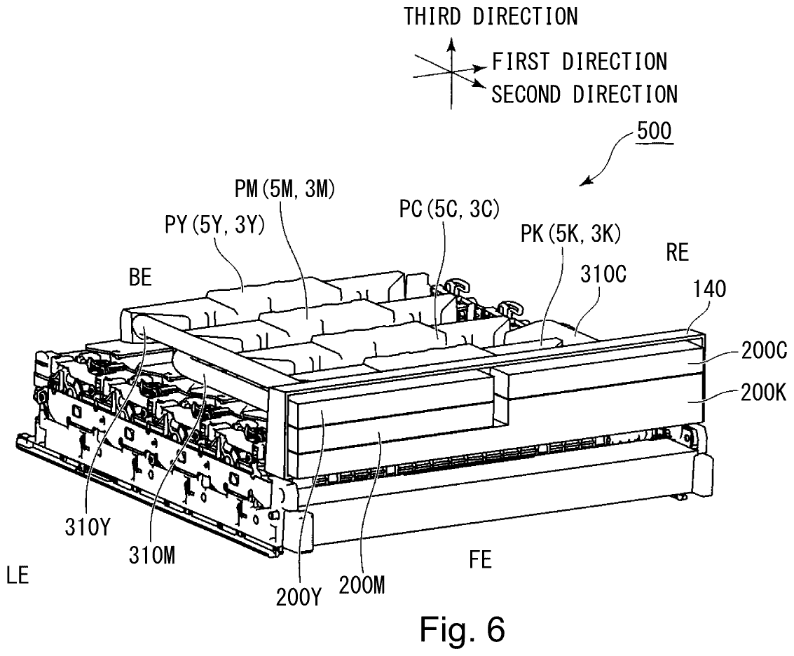

Next, with reference to FIGS. 6 to 10, a toner conveying path (toner supplying path) from the cartridges 200 toward the developing containers 3 will be described.

Here, a unit including the process units PY, PM, PC, and PK, the cartridge holder 140, the cartridges 200Y, 200M, 200C, and 200K, and a supplying mechanism 300 described later is referred to as the image forming unit 500. The supplying mechanism 300 is constituted by including supply pipes 310 (310Y, 310M, 310C, 310K) (FIGS. 6 to 10) and conveying devices 320 (320Y, 320M, 320C, 320K) (FIG. 12) which are described later.

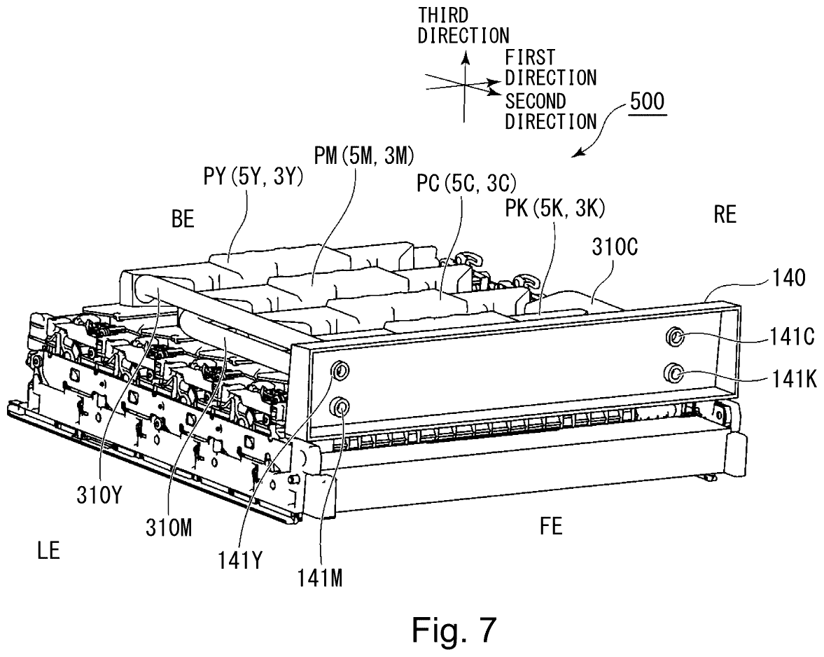

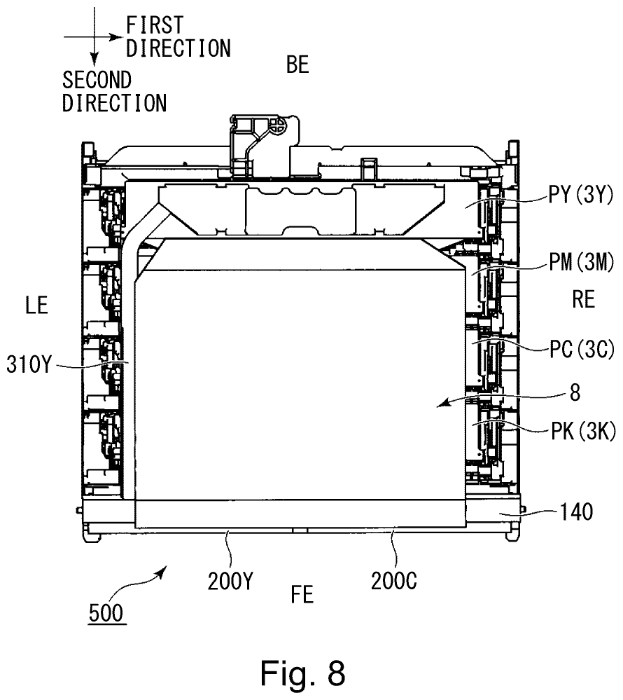

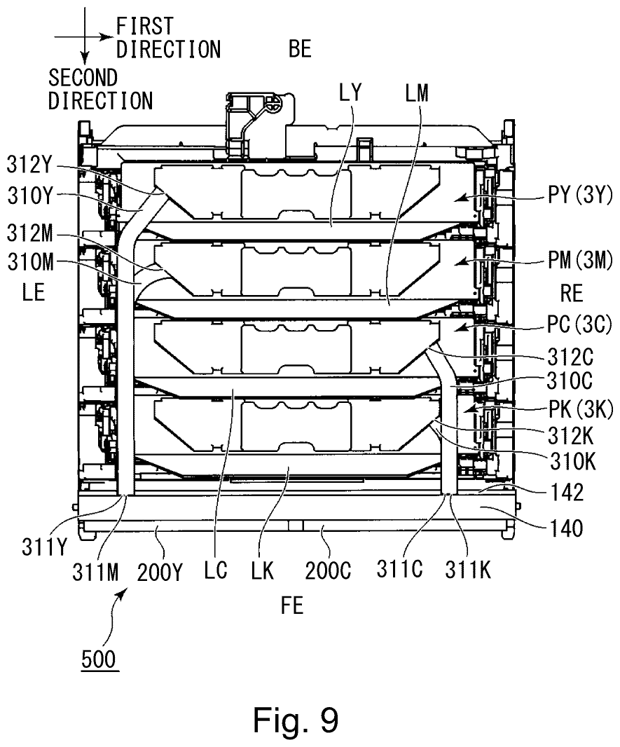

FIG. 6 is a perspective view of the image forming unit 500 in a state in which the cartridges 200Y, 200M, 200C, and 200K are mounted. FIG. 7 is a perspective view of the image forming unit 500 in a state in which the cartridges 200Y, 200M, 200C, and 200K are demounted. FIG. 8 is a plan view of the laser scanner unit 8 and the image forming unit 500 as viewed in the third direction from above. FIG. 9 is a plan view of the image forming unit 500 as viewed in the third direction from above, and in which optical paths LY, LM, LC, and LK of laser light from the laser scanner unit 8 toward the photosensitive drums 1Y, 1M, 1C, and 1K are illustrated. FIG. 10 is a side view of the laser scanner unit 8 and the image forming unit 500 as viewed in the first direction from the left side surface side.

As shown in FIG. 7, the cartridge holder 140 is provided with receiving openings 141Y, 141M, 141C, and 141K for receiving toner discharged through the discharge openings 201Y, 201M, 201C, and 201K provided to the cartridges 200Y, 200M, 200C, and 200K, respectively. A front surface side end portion of the receiving opening 141 is disposed on a side surface 144 of the cartridge holder 140 on a front surface side (FIG. 7). Further, a rear surface side end portion of the receiving opening 141 is disposed on a side surface 142 of the cartridge holder 140 on a rear surface side (FIGS. 9 and 10).

The receiving openings 141 are disposed in two positions on each of the left side surface side and the right side surface side.

The supply pipes 310Y, 310M, 310C, and 310K as paths through which the toner moved from the cartridges 200Y, 200M, 200C, and 200K toward the developing containers 3Y, 3M, 3C, and 3K are provided so as to be positioned in the main assembly casing 120. Each supply pipe 310 constitutes a toner conveying path from the cartridge 200 toward the developing container 3. An end portion of the supply pipe 310 on a cartridge 200 side (discharge opening 201 side) is an upstream end portion 311 (311Y, 311M, 311C, 311K). Further, an end portion of the supply pipe 310 on a developing container 3 side in a downstream end portion 312 (312Y, 312M, 312C, 312K).

To rear surface side end portions of the receiving openings 141Y, 141M, 141C, and 141K, the upstream end portions 311Y, 311M, 311C, and 311K of the supply pipes 310Y, 310M, 310C, and 310K are connected, respectively. By this, the receiving opening 141 and an inside of the supply pipe 310 communicate with each other so as to permit movement of the toner. Further, when the cartridges 200Y, 200M, 200C, and 200K are mounted in predetermined positions of the cartridge holder 140, the discharge openings 201Y, 201M, 201C, and 201K and the receiving openings 141Y, 141M, 141C, and 141K are connected to each other, respectively. By this, an inside of the cartridge 200 and an inside of the supply pipe 310 communicate with each other toner the discharge opening 201 and the receiving opening 141 so as to permit the movement of the toner. The downstream end portions 312Y, 312M, 312C, and 312K of the supply pipes 310Y, 310M, 310C, and 310K are connected to the developing containers 3Y, 3M, 3C, and 3K, respectively. By this, the inside of the developing container 3 and the inside of the supply pipe 310 communicate with each other so as to permit the movement of the toner.

Incidentally, the discharge opening 201 and the receiving opening 141 can be connected to each other by an arbitrary connecting means when leakage of the toner through between these openings can be sufficiently suppressed. For example, it is possible to use a constitution in which these openings are connected to each other by inserting either one of the discharge opening 201 and the receiving opening 141 into an inside of the other opening, a constitution in which these openings are connected to each other by bringing end surfaces constituting edge portions of the discharge opening 201 and the receiving opening 141 into contact with each other, or the like constitution. Further, a sealing member for suppressing leakage of the toner from a connecting portion between the discharge opening 201 and the receiving opening 141 may be provided.

The toner discharged from the inside of the cartridge 200 through the discharge opening 201 and received through the receiving opening 141 is moved inside the supply pipe 310 from the upstream end portion 311 to a downstream end portion 444, and is supplied to the inside of the developing container 3. As a conveying means for conveying the toner toward the developing container 3 through the supply pipe 310, it is possible to use a constitution in which the toner is conveyed together with air by using a pump, a constitution using a screw, a constitution using a belt conveyer, or the like constitution. An example of this conveying means will be described later.

### <Arrangement of Supply Pipes and Discharge Openings>

Next, with reference to FIGS. 6 to 11, arrangement of the supply pipes 310Y, 310M, 310C, and 310K and the discharge openings 201Y, 201M, 201C, and 201K will be described. Parts (a) and (b) of FIG. 11 are schematic views for illustrating a positional relationship between the optical path L (LY, LM, LC, LK) of the laser light and the discharge opening 201 (or the upstream end portion 311 of the supply pipe 310) as viewed in the second direction (in which only one end portion side of the optical path L with respect to the first direction is illustrated).

The supply pipes 310Y, 310M, 310C, 310K are disposed while avoiding the optical paths LY, LM, LC, and LK so as not to block the optical paths LY, LM, LC, and LK of the laser light emitted from the laser scanner unit 8 toward the photosensitive drums 1Y, 1M, 1C, and 1K during the image formation. In this embodiment, the supply pipes 310Y, 310M, 310C, and 310K (particularly, at least a part thereof including the upstream end portions 311Y, 311M, 311C, and 311K) are disposed so as not to overlap with either one of the optical paths LY, LM, LC, and LK as viewed in the second direction. Here, in this embodiment, as shown in FIG. 9, the optical path L of the laser light emitted from the laser scanner unit 8 to the photosensitive drum 1 becomes wider in width in the first direction as the optical path L approaches from the exposure window 7 of the laser scanner unit 8 toward the photosensitive drum 1. In such a constitution, as shown in FIG. 9 and part (a) of FIG. 11, at least a part of the supply pipe 310 (upstream end portion 311) with respect to the first direction may be positioned within a range LW of the optical path L. Even in this case, when the supply pipe 310 does not overlap with the optical path L as viewed in the second direction, simplification of the toner conveying path can be realized while avoiding blocking of the optical path L by the supply pipe 310. Further, by employing such a constitution, a size of the image forming apparatus 100 in the first direction is advantageously reduced. However, as shown in part (b) of FIG. 11, with respect to the first direction, the supply pipe 310 may also be positioned outside the range LW of the optical path L.

In this embodiment, with respect to the first direction, two supply pipes 310 are disposed on each of the left side surface side and the right side surface side while sandwiching the optical paths LY, LM, LC, and LK therebetween. That is, the supply pipe 310Y for yellow and the supply pipe 310M for magenta are disposed on the left side surface side, and the supply pipe 310C for cyan and the supply pipe 310K for black are disposed on the right side surface side. Further, the supply pipe 310Y for yellow and the supply pipe 310M for magenta are constituted so that at least a part of the supply pipe 310Y for yellow and at least a part of the supply pipe 310M for magenta overlap with each other as viewed in the third direction. In this embodiment, the supply pipe 310Y for yellow and the supply pipe 310M for magenta are constituted so that parts thereof at least including the upstream end portions 311Y and 311M overlap with each other as viewed in the third direction. Similarly, the supply pipe 310C for cyan and the supply pipe 31GK for black are constituted so that at least a part of the supply pipe 310C for cyan and at least a part of the supply pipe 31GK for black overlap with each other as viewed in the third direction. In this embodiment, the supply pipe 310C for cyan and the supply pipe 31GK for black are constituted so that parts thereof at least including the upstream end portions 311C and 311K overlap with each other as viewed in the third direction.

Thus, in this embodiment, the two supply pipes 310 disposed on each of the left side surface side and the right side surface side are constituted so as to overlap with each other in at least a part thereof including the upstream end portion 311 thereof connected to the cartridge holder 140 in the case where the two supply pipes 310 are viewed in the third direction. Further, in this embodiment, each of the supply pipes 310Y, 310M, 310C, and 31GK extends so that at least a part thereof including the upstream end portion 311 extends substantially linearly from the cartridge holder 140 in a position where the supply pipe avoids the optical path L as described above.

Incidentally, in this embodiment, as shown in FIGS. 8 and 10, the supply pipes 310Y, 310M, 310C, and 310K are disposed on a lower side with respect to the laser scanner unit 8. Further, in this embodiment, the supply pipes 310Y, 310M, 310C, and 310K are disposed on an upper side with respect to the photosensitive drums 1Y, 1M, 1C, and 1K. Further, in this embodiment, the two supply pipes 310Y and 310M disposed on the left side surface side are disposed by being separated upward and downward, and the two supply pipes 310C and 310K are disposed by being separated upward and downward. However, even if these supply pipes are capable of avoiding the optical paths LY, LM, LC, and LK and other peripheral component parts, the plurality of supply pipes 310 disposed on each of the left side surface side and the right side surface side may also be constituted so as to vertically overlap with each other in at least parts thereof.

Further, in order to enable the above-described arrangement of the supply pipes 310Y, 310M, 310C, and 310K, the discharge openings 201Y, 201M, 201C, 201K of the cartridges 200Y, 200M, 200C, and 200K are disposed as follows. That is, each of the discharge openings 201Y, 201M, 201C, and 201K is provided in an end portion of the associated cartridge 200, with respect to the first direction, adjacent to the associated end portion of the image forming apparatus 100 with respect to the first direction (FIG. 5).

Particularly, in this embodiment, each of the discharge openings 201Y, 201M, 201C, and 201K is disposed so as not to overlap with either one of the optical paths LY, LM, LC, and LK as viewed in the second direction (FIGS. 9 and 11). Similarly as in the case of the supply pipe 310 (upstream end portion 311), as shown in part (a) of FIG. 11, at least a part of the discharge opening 201 with respect to the first direction may be positioned within the range LW of the optical path L, and as shown in part (b) of FIG. 11, with respect to the first direction, the discharge opening 201 with respect to the first direction may be positioned outside the range LW of the optical path L.

In this embodiment, the cartridge 200Y for yellow and the cartridge 200M for magenta are disposed so as to overlap with each other with respect to the third direction, and each of left side surface side end portions thereof with respect to the first direction is disposed adjacently to the left side surface side end portion of the image forming apparatus 100. For that reason, the discharge openings 201Y and 201M of the cartridges 200Y and 200M can be disposed in the left side surface side end portions of the cartridges 200Y and 200M, respectively, adjacent to the left side surface side end portion of the image forming apparatus 100 with respect to the first direction (FIG. 5). Further, in this embodiment, the cartridge 200C for cyan and the cartridge 200K for black (second region A2) are disposed so as to overlap with each other with respect to the third direction, and each of right side surface side end portions thereof with respect to the first direction is disposed adjacently to the right side surface side end portion of the image forming apparatus 100. For that reason, the discharge openings 201C and 201K of the cartridges 200C and 200K can be disposed in the right side surface side end portions of the cartridges 200C and 200K, respectively, adjacent to the right side surface side end portion of the image forming apparatus 100 with respect to the first direction (FIG. 5). Thus, in this embodiment, the discharge openings 201 are disposed in two positions on each of the left side surface side and the right side surface side.

Incidentally, opposite end portions of the cartridge 200K for black with respect to the first direction are adjacent to the end portions of the image forming apparatus 100 with respect to the first direction, respectively. For that reason, the discharge opening 201 of the cartridge 200K for black (and the supply pipe 310K for black) can be arbitrarily disposed on either one of the left side surface side and the right side surface side with respect to the first direction.

Here, as described in JP-A No. 2023-7030, in the case where if the four cartridges 200Y, 200M, 200C, and 200K are aligned and disposed in the first direction, the following arrangement is made. At least two cartridges 200 which are not adjacent to the end portions of the image forming apparatus 100 and which are disposed inside the image forming apparatus 100 are required to bypass the supply pipe 310 from the upstream end portions 311 to an outside of the optical paths once in order to avoid the optical paths LY, LM, LC, and LK.

On the other hand, in this embodiment, one end portion of each of the cartridges 200Y, 200M, 200C, and 200K with respect to the first direction is disposed adjacently to either one of the end portions of the image forming apparatus 100 with respect to the first direction. For that reason, as shown in FIGS. 9 and 11, as viewed in the second direction, the upstream end portion 311 of the supply pipe 310 can be disposed in a position where the upstream end portion 311 does not overlap with the optical path L. Accordingly, according to this embodiment, the toner conveying path from the cartridge 200 toward the developing container 3 can be simplified. For that reason, a space in the image forming apparatus 100 is effectively utilized, so that downsizing of the image forming apparatus 100 and upsizing of volume (capacity) of the cartridge 200 can be realized. Further, by employing a constitution in which the cartridges 200 are disposed so as to convey with each other with respect to the third direction, a degree of freedom in shape for increasing the volume of the cartridges 200 is increased. For that reason, the cartridge 200K for black can be disposed adjacently to the opposite end portions of the image forming apparatus 100 with respect to the first direction. Further, a constitution in which the cartridge 200K for black is disposed so that at least a part thereof overlaps with the cartridges for all other colors with respect to the third direction can be employed. By this, an increase in volume of the cartridge 200K for black can be realized, and in addition, the toner conveying path from the cartridge 200 toward the developing container 3 is simplified, so that a toner accommodating volume of the cartridge 200 can be largely ensured.

Incidentally, in this embodiment, the upstream end portion 311 of the supply pipe 310 is disposed on the side surface 142 of the cartridge holder 140 on the rear surface side (FIGS. 9 and 10), but may also be disposed on a side surface 143 of the cartridge holder 140 on the left side surface side or the right side surface side (FIG. 5). In this case, correspondingly to a position of the upstream end portion 311 of the supply pipe 310, the receiving opening 141 and the discharge opening 201 may only be required to be disposed on the left side surface side or the right side surface side.

### <Conveying Means>

Next, an example of the conveying device as a conveying means for conveying the toner from the cartridge 200 toward the developing container 3 through the supply pipe 310 will be described. Part (a) of FIG. 12 is a perspective view, of the image forming unit 500 in a state in which the cartridges 200 are mounted, for illustrating the example of the conveying device 320 (320Y, 320M, 320C, 320K). Part (b) of FIG. 12 is a front view, of the image forming unit 500 in the state in which the cartridges 200 are mounted, for illustrating the example of the conveying device 320 as viewed in the second direction from the front surface side.

The conveying device 320 in this embodiment is a conveying device of a pressure feeding type. Constitutions and operations of the conveying devices 320Y, 320M, 320C, and 320K for the colors of yellow, magenta, cyan, and black, respectively, are similar to each other. In this embodiment, the conveying device 320 is constituted by including diaphragm pumps 321 (321Y, 321M, 321C, 321K). As the diaphragm pumps 321, it is possible to use available diaphragm pumps that have an arbitrary constitution, such as well-known diaphragm pumps can be used. In this embodiment, the diaphragm pumps 321 are mounted to the cartridge holder 140. The diaphragm pumps 321 include motor units 322 (322Y, 322M, 322C, 322K) and diaphragm units 323 (323Y, 323M, 323C, 323K). The diaphragm units 323 are suction ports (not shown) for sucking air and discharge ports 324 (324Y, 324M, 324C, 324K) for permitting discharge of the air. Each of the discharge ports 324 extends to an inside of a region in which the associated cartridge 200 is mounted to the cartridge holder 140. Incidentally, to the discharge port 324 of the diaphragm pump 321, an air flow path such as a tube 324a is connected, and the discharge port 324 may also be extended to an apparatus position in the cartridge holder 140. Further, the cartridge 200 can be appropriately provided with a groove (recessed portion) 203 so as to avoid the tube 324a.

The cartridges 200 are provided with air receiving ports 202 (202Y, 202M, 202C, 202K) for receiving the air, discharged through the discharge port 324, to the inside of the cartridges 200. When the cartridge 200 is mounted to the cartridge holder 140 in a predetermined position, the discharge port 324 and the air receiving port 202 are connected to each other. In order to efficiently discharge the toner, accommodated inside the cartridge 200, through the discharge opening 201, it is preferable that the air receiving port 202 is provided in an end portion of the cartridge 200 on a side opposite from the discharge opening 201.

When the toner is conveyed from the cartridge 200 toward the developing container 3 through the supply pipe 310, the diaphragm pump 321 is driven, so that the air is discharged through the discharge port 324. An operation principle of the diaphragm pump 321 is well known, so that detailed description thereof will be omitted. For example, a diaphragm (film) of the diaphragm unit 323 is moved by an eccentric shaft connected to an output shaft of the motor unit 322, so that inside pressure of the diaphragm unit 323 is changed. The diaphragm unit 323 is provided with a valve for opening and closing the suction port and a valve for opening and closing the discharge port 324. Further, these valves are opened and closed depending on a change in inside pressure of the diaphragm unit 323, so that the air sucked through the suction port is discharged through the discharge port 324. This air is received inside (sent into) the cartridge 200 through the air receiving port 202. By this, the toner is discharged together with the air through the discharge opening 201, so that the toner is supplied to the developing container 3 through the supply pipe 310. Incidentally, the developing container 3 may be provided with an air exhaust port for exhausting the air through a filter for suppressing flowing-out of the toner.

Here, the supply of the toner from the cartridge 200 to the developing container 3 may be performed at once in the case where the toner in the developing container 3 is used up or in the like case, or may also be performed successively depending on a decrease in amount of the toner in the developing container 3. Further, in the case where the toner supply is performed at once, the cartridge 200 is demounted from the apparatus main assembly 110 after the toner supply is ended, and in that state, image formation may also be carried out.

Incidentally, as described above, the conveying means for conveying the toner from the cartridge 200 to the developing container 3 is not limited to a constitution in which the toner is conveyed together with the air by using the pump.

For example, a constitution using a screw, a constitution using a belt conveyor, or the like constitution may also be used. For example, the screw is provided in the cartridge 200, and the toner can be discharged through the discharge opening 201. Further, for example, the screw is provided in the supply pipe 310, and the toner can be conveyed from the upstream end portion 311 to the downstream end portion 312 of the supply pipe 310. In the constitution using the screw, as a driving source for rotating the screw, a motor of a driving portion for driving the photosensitive drum 1 or the intermediary transfer belt 11 may be utilized, or a dedicated motor may be provided. Further, different conveying means as described above may be used appropriately in combination.

As described above, according to this embodiment, simplification of the toner conveying path from the cartridge 200 to the developing container 3 is realized, and an increase in volume of the cartridge 200K for black can be realized while enabling effective utilization of a space.

Incidentally, the process unit P may be mounted in the main assembly casing 120 so that the process unit P cannot be easily mounted in and demounted from the main assembly casing 120. Or, the process unit P may also be made detachably mountable to the apparatus main assembly 110. In this case, the four process units P may be individually made detachably mountable the apparatus main assembly 110, or a plurality (which may be all) of the four process units P may be made integrally detachably mountable to the apparatus main assembly 110. Further, the image forming units 500 may be made integrally detachably mountable to the apparatus main assembly 110.

Further, in this embodiment, with respect to the second direction, the cartridges 200Y, 200M, 200C, and 200K are disposed so as not to overlap with the process units PY, PM, PC, and PK (non-overlapping with process units P).

Here, “non-overlapping with process units P” means that the cartridges 200 do not overlap with elements constituting the process units P, typically, the developing containers 3 and the drum unit frames 61 which constitute outer configurations of the process units P. However, for example, with respect to the second direction, at least a part of at least one cartridge 200 may be disposed so as to overlap with at least a part of a process cartridge P (for example, the process unit P positioned closest to the main assembly opening 121 in the second direction).

### Embodiment 2

Next, another embodiment (embodiment 2) of the present disclosure will be described. Basic constitution and operation of an image forming apparatus according to this embodiment are the same as those of the image forming apparatus of the embodiment 1. Accordingly, in the image forming apparatus of this embodiment, elements having identical or corresponding functions to those of the image forming apparatus of the embodiment 1 will be omitted from detailed description by adding thereto the same reference numerals or symbols as those in the embodiment 1.

Part (a) of FIG. 13 is a front view of the image forming unit 500 in this embodiment as viewed in the second direction from the front surface side. Further, part (b) of FIG. 13 is a perspective view of the image forming unit 500 in this embodiment.

In this embodiment, similarly as in the embodiment 1, in the case where the cartridge 200K for black is viewed in the second direction from the front surface side, the cartridge 200K for black has a L-character shape. That is, also in this embodiment, the cartridge 200K for black includes a first region A1 and a second region A2 similar to those described in the embodiment 1. However, in this embodiment, on the left side surface side, the cartridge 200Y for yellow, the cartridge 200M for magenta, the cartridge 200C for cyan, and the cartridge 200K for black (first region A1) are disposed so as to overlap with each other with respect to the third direction. Further, on the right side surface side, only the cartridge 200K for black (second region A2) is disposed. That is, in this embodiment, similarly as in the embodiment 1, the first region A1 is disposed on an end portion side of the left side surface side of the image forming apparatus 100 with respect to the first direction, and the second region A2 is disposed on an end portion side of the right side surface side of the image forming apparatus 100 with respect to the first direction. On the other hand, in this embodiment, the cartridges 200Y, 200M, and 200C for yellow, magenta, and cyan, respectively, are shifted and disposed to the end portion of the image forming apparatus 100 on the left side surface side with respect to the first direction. That is, in this embodiment, the cartridges 200Y, 200M, and 200C for yellow, magenta, and cyan, respectively, are disposed in positions, with respect to the first direction, closer to the end portion (first end portion) of the image forming apparatus 100 on the left side surface side than to an end portion (second end portion) of the image forming apparatus 100 on the right side surface side. Further, each of the cartridges 200Y, 200M, and 200K for yellow, magenta, and cyan, respectively, and the cartridge 200K for black (second region A2) are disposed so as to overlap with each other with respect to the first direction. In the constitution of this embodiment, compared with the constitution of the embodiment 1, a further increase in volume of the cartridge 200K for black can be realized.

Incidentally, in this embodiment, a first width W1 of the first region A1 is substantially the same as a width of each of the cartridges 200Y, 200M, and 200K for yellow, magenta, and cyan, respectively, with respect to the third direction. Further, in this embodiment, a second width W2 of the second region A2 is substantially four times the width of each of the cartridges 200Y, 200M, and 200C for yellow, magenta, and cyan, respectively, with respect to the third direction. Further, in this embodiment, the cartridges 200Y, 200M, and 200K for yellow, magenta, and cyan, respectively, have substantially the same outer configuration (substantially rectangular parallelopiped shape long in the first direction).

Further, each of the discharge openings 201Y, 201M, 201C, and 201K is provided in an end portion, of the associated cartridge 200 with respect to the first direction, adjacent to the associated end portion of the image forming apparatus 100 with respect to the first direction. Particularly, in this embodiment, each of the discharge openings 201Y, 201M, 201C, and 201K is disposed so as not to overlap with either one of the port paths LY, LM, LC, and LK as viewed in the second direction. In this embodiment, the discharge openings 201Y, 201M, and 201C of the cartridges 200Y, 200M, and 200C for yellow, magenta, and cyan, respectively, are disposed in left side surface side end portions of the cartridges 200Y, 200M, and 200C adjacent to the left side surface side end portion of the image forming apparatus 100 with respect to the first direction. Further, in this embodiment, the discharge opening 201K of the cartridge 200K for black is disposed in a right side surface side end portion of the cartridge 200K adjacent to the right side surface side end portion of the image forming apparatus 100 with respect to the first direction. Thus, in this embodiment, the discharge openings 201 are disposed in three positions on the left side surface side and one position on the right side surface side.

Incidentally, in this embodiment, the cartridges 200Y, 200M, 200C, and 200K for yellow, magenta, cyan, and black, respectively, are arranged as described above (color arrangement), but as regards the yellow, the magenta, and the cyan, the color arrangement may also be a different color arrangement from this embodiment. Further, the color arrangement of the cartridges disposed so as to convey with each other with respect to the third direction is such that four colors are disposed on the left side surface side and one color is disposed on the right side surface side, but may also be such that the one color is disposed on the left side surface side and the four colors are disposed on the right side surface side. Further, thus, in the case where the one color is disposed on the left side surface side and the four colors are disposed on the right side surface side, the discharge openings 201 can be disposed in one position on the left side surface side and three positions on the right side surface side.

Further, in this embodiment, the upstream end portions 311 of the supply pipes 310 are disposed on the side surface 142 of the cartridge holder 140 on the rear surface side, but may also be disposed on the side surface 143 of the cartridge holder 140 on the left side surface side or the right side surface side with respect to the first direction. In this case, correspondingly to positions of the upstream end portions 311 of the supply pipes 310, the receiving openings 141, and the discharge openings 201 may only be required to be disposed on the left side surface side or the right side surface side.

As described above, according to this embodiment, an effect similar to the effect of the embodiment 1 can be obtained, and in addition, a further increase in volume of the cartridge 200K for black can be realized.

### OTHER EMBODIMENTS

As described above, the present disclosure was described in accordance with specific embodiments (embodiments 1 and 2), but the present disclosure is not limited to the above-described embodiments.

In the develop embodiments, the image forming apparatus employed the intermediary transfer type, but the present disclosure is not limited thereto. The image forming apparatus may also be an image forming apparatus in which a direct transfer type such that toner images are successively transferred from a plurality of photosensitive drums onto a recording material carried on a recording material carrying member (recording material conveyor belt or the like), for example.

Further, a supply developer supplied from the cartridge to the developing container may also be a developer including the toner and a carrier, i.e., a so-called two-component developer.

Further, although omitted from description, also in the embodiment 2, a conveying means similar to the conveying means described in the embodiment 1 can be used. In this case, depending on arrangement of the cartridges, positions of the discharge ports and the air receiving ports may only be required to be appropriately changed.

Further, in the above-described embodiments, the image forming apparatus is provided with the four toner cartridges and the four process units, but the numbers of the toner cartridges and the process units are not limited thereto and are appropriately set as needed. The numbers of cartridges provided detachably mountable to the image forming apparatus is not limited to four, but may also be five or more (for example, six) or may also be three or less (for example, three).

### Embodiment 3

### <Constitution of Image Forming Apparatus.

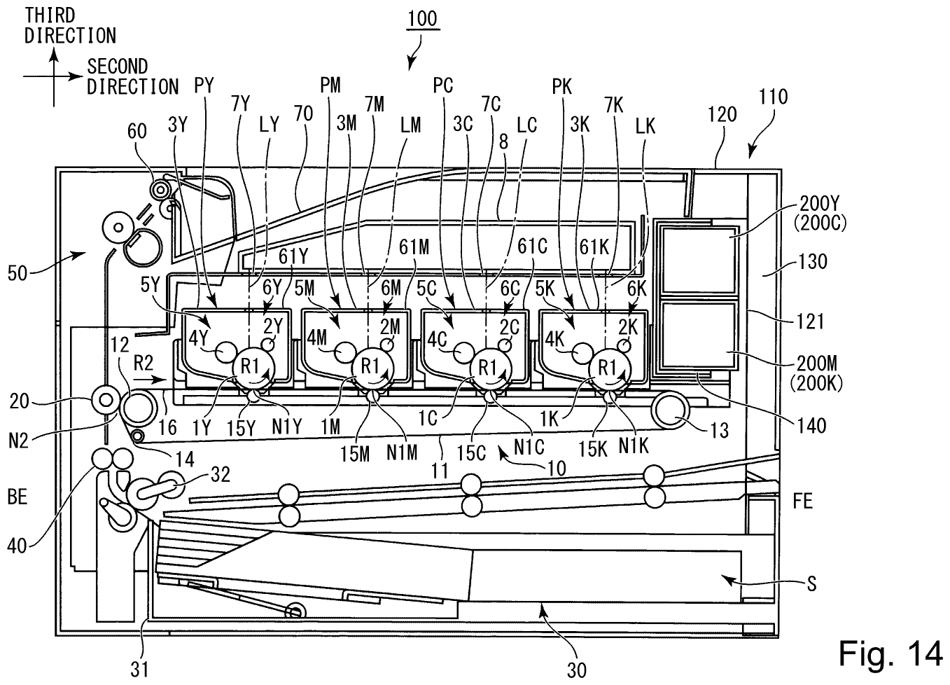

FIG. 14 is a schematic sectional view showing a schematic constitution of an image forming apparatus 100 of an embodiment 1 (shows a cross section substantially perpendicular to a rotational axis direction of a photosensitive drum 1 described later). The image forming apparatus 100 is a tandem-type full-color laser printer employing an intermediary transfer type in which a full-color image is capable of being formed on a sheet-like recording material S by using an image forming process (electrophotographic process) of an electrophotographic type.

The image forming apparatus 100 includes, in a main assembly casing 120, four process units PY, PM, PC, and PK as a plurality of process units. The four process units PY, PM, PC, and PK form toner images (toner pictures, developer images) of colors of yellow (Y), magenta (M), cyan (C), and black (K), respectively. Incidentally, constitutions of the four-process units PY, PM, PC, and PK are similar to each other except that colors of toner accommodated inside developing containers 3 of developing units 5 described later are different from each other. As regards elements, having the same or corresponding functions or constitutions, provided for the respective colors will be collectively described in some instances by omitting suffixes of reference numerals or symbols each showing the element for the associated color.

The four process units PY, PM, PC, and PK are aligned and disposed along (in this embodiment, substantially parallel to) a movement direction of a primary transfer surface 16 of an intermediary transfer belt 11 described later. Specifically, the photosensitive drums 1 and developing units 5 which constitute the four process units PY, PM, PC, and PK, respectively, are aligned and disposed along (in this embodiment substantially parallel to) the movement direction of the primary transfer surface 16 of the intermediary transfer belt 11.

Here, as regards the image forming apparatus 100 and elements thereof, the rotational axis direction of the photosensitive drum 1 (a longitudinal direction of the process unit P, the developing unit 5, a drum unit 6) is referred to as a “first direction (X direction)”. that is, the photosensitive drum 1 is rotatable bout a rotational axis extending in the first direction. Further, as regards the image forming apparatus 100 and elements thereof, a direction perpendicular to the first direction is referred to as a “second direction (Y direction)”. The four process cartridges PY, PM, PC, and PK are aligned and disposed in the second direction. That is, an alignment direction of the four process units PY, PM, PC, and PK (specifically, the photosensitive drums 1 and the developing units 5) is the second direction. Further, as regards the image forming apparatus 100 and the elements thereof, a direction perpendicular to both the first direction and the second direction is referred to as a “third direction (Z direction)”. Further, as regards the image forming apparatus 100 and the elements thereof, up (upper) and down (lower) refer to those with respect to a gravitational direction (vertical direction), but do not mean only immediately on (above) and immediately under (below), respectively, and include an upper side and a lower side than a horizontal surface (plane) passing through a noticed position or a noticed element. The image forming apparatus 100 is disposed so that the first direction becomes substantially parallel to a horizontal direction and so that the second direction crosses the gravitational direction, and is used for image formation. In FIG. 14, the image forming apparatus 100 is drawn so that the second direction becomes substantially parallel to the horizontal direction, but as seen in FIG. 10, the second direction may also have an angle with respect to the horizontal direction. Further, as regards the image forming apparatus 100, a right side in FIG. 14 is a “front surface (FE)” side, a left side in FIG. 14 is a “rear (back) surface (BE)” side, a left side as viewed from the front surface side is a “left side surface (LE)” side, and a right side as viewed from the front surface side is a “right side surface (RE)” side. In this embodiment, the four process units PY, PM, PC, and PK are arranged in this order from the rear (back) surface side toward the front surface side along the second direction.

The process unit P includes electrophotographic process elements. To the process unit P, a rotational driving force of a rotatable member (the photosensitive drum 1, a developing roller 4, or the like described later) is transmitted from a drive output portion (not shown) provided in the main assembly casing 120. Further, to the process unit P, a bias voltage (a charging bias, a developing bias, or the like described later) is supplied from a bias applying portion (not shown) provided in the main assembly casing 120.

The process unit P includes the drum unit 6 (6Y, 6M, 6C, 6K). The drum unit 6 (6Y, 6M, 6C, 6K) includes the photosensitive drum 1 (1Y, 1M, 1C, 1K) and a charging roller 2 (2Y, 2M, 2C, 2K) which is a roller-type charging member as a charging means for electrically charging the photosensitive drum 1. The charging roller 2 constitutes process means acting on the photosensitive drum 1. The photosensitive drum 1 is rotatable about the rotational axis extending in the first direction. The drum unit 6 is constituted by that the photosensitive drum 1, the charging roller 2, and the like are held by a drum unit frame 61.

Further, the process unit P includes the developing unit (developing device) 5 (5Y, 5M, 5C, 5K) as a developing means for developing an electrostatic latent image formed on the photosensitive drum 1. The developing unit 5 constitutes the process means acting on the photosensitive drum 1. The developing unit 5 includes a developing container 3 (3Y, 3M, 3C, 3K) for accommodating toner as a developer and the developing roller 4 (4Y, 4M, 4C, 4K) as a developer carrying member (developing member). The developing containers 3Y, 3M, 3C, and 3K accommodate yellow toner, magenta toner, cyan toner, and black toner, respectively. The developing roller 4 carries and conveys the toner accommodated in the developing container 3 and supplies the toner to a surface of the photosensitive drum 1. In this embodiment, the toner as the developer is a non-magnetic one-component developer. Further, in this embodiment, the developing unit 5 causes the toner, charged to the same polarity as a charging polarity (negative polarity in this embodiment) of the photosensitive drum 1, to be deposited on an exposed portion on the photosensitive drum 1 lowered in absolute value of a potential by being exposed to light after being uniformly charged. In this embodiment, a normal charge polarity of the toner which is a principal charge polarity of the toner during development is the negative polarity. The developing unit 5 is constituted by that the developing roller 4 or the like is held by a frame constituting the developing container 3.

In the main assembly casing 120, above the process unit P, a laser scanner unit (exposure unit, exposure device) 8 as an exposure means for forming the electrostatic latent image (electrostatic image) on the photosensitive drum 1 by exposing the photosensitive drum 1 to light is provided. The laser scanner unit 8 outputs laser light corresponding to image signals (image information) of the colors of yellow, magenta, cyan, and black and irradiates the photosensitive drums 1Y, 1M, 1C, and 1K, respectively. Optical paths of the laser light from the laser scanner unit 8 toward the photosensitive drums 1Y, 1M, 1C, and 1K are referred to as optical sheets LY, LM, LC, and LK, respectively. The laser light passes through an exposure window 7 (7Y, 7M, 7C, 7K) of the laser scanner unit 8, so that the surface of the photosensitive drum 1 is subjected to scanning exposure to the laser light. Incidentally, the exposure means is not limited to the laser scanner unit 8, but may also be an LED exposure unit, for example.

In the main assembly casing 120, below the process unit P (on a side opposite from the laser scanner unit 8 while sandwiching between the laser scanner unit 8 and an intermediary transfer belt unit 10 in a third direction), the intermediary transfer belt unit 10 as a transfer device is provided. The intermediary transfer belt unit 10 includes an intermediary transfer belt 11 as an intermediary transfer member, a driving roller 12, a tension roller 13, and an assisting roller 14 which are as a plurality of stretching surfaces, and primary transfer rollers 15Y, 15M, 15C, and 15K which are as primary transfer means. The intermediary transfer belt 11 constituted by a flexible endless belt is extended around the driving roller 12, the tension roller 13, and the assisting roller 14, and is stretched under predetermined tension. Lower surfaces of the photosensitive drums 1Y, 1M, 1C, and 1K contact a primary transfer surface 16 which is an upper surface of the intermediary transfer belt 11. The primary transfer surface 16 is a surface of the intermediary transfer belt 11 onto which a toner image is transferred from the photosensitive drum 1 and is constituted by a surface of the intermediary transfer belt 11 stretched by the driving roller 12 and the tension roller 13. On an inner peripheral surface side of the intermediary transfer belt 11, in positions opposing the photosensitive drums 1Y, 1M, 1C, and 1K through the intermediary transfer belt 11, the primary transfer rollers 15Y, 15M, 15C, and 15K which are roller-type primary transfer members as primary transfer means are disposed, respectively.

The primary transfer roller 15 is pressed toward the photosensitive drum 1 through the intermediary transfer belt 11 and forms a primary transfer portion N1 (N1Y, N1M, N1C, N1K) which is a contact portion between the photosensitive drum 1 and the intermediary transfer belt 11. Further, on an outer peripheral surface side of the intermediary transfer belt 11, in a position opposing the driving roller 12 through the intermediary transfer belt 11, a secondary transfer roller 20 as a secondary transfer means is provided. The secondary transfer roller 20 is pressed toward the driving roller 12 through the intermediary transfer belt 11 and forms a secondary transfer portion which is a contact portion between the intermediary transfer belt and the secondary transfer roller 20.

In the main assembly casing 120, below the intermediary transfer belt 11, a feeding unit 30 as a feeding means is provided. The feeding unit 30 includes a feeding tray 31 as a recording material accommodating portion for accommodating a recording material (recording medium, transfer material, sheet) S such as paper or a plastic sheet, and a feeding roller 32 as a feeding member for picking up and conveying the recording material S from the feeding tray 31. Further, in the main assembly casing 120, a registration roller pair 40 as a conveying member is provided on a side downstream of the feeding unit 30 and upstream of the secondary transfer portion N2 with respect to a conveying direction of the recording material S.

Further, in the main assembly casing 120, a fixing unit (fixing device) 50 as a fixing means for fixing the toner image on the recording material S is provided on a side downstream of the secondary transfer portion N2 (above the process unit P) with respect to the conveying direction of the recording material S. Further, in the main assembly casing 120, a discharging roller 60 for discharging the recording material S, on which the toner image is formed, to an outside of the main assembly casing 120 is provided on a side downstream of the fixing unit 50 (above the fixing unit 50) with respect to the conveying direction of the recording material S. Further, outside (on an upper portion of) the main assembly casing 120, a discharge tray 70 on which the recording material S discharged from the inside of the main assembly casing 120 is stacked is provided.

Here, in this embodiment, the discharging roller 60 discharges the recording material S is a direction from the rear surface side toward the front surface side along the second direction. That is, in this embodiment, a downstream side in a discharging direction of the recording material S by the discharging roller 60 is a front surface side (front side) of the image forming apparatus 100, and an upstream side in the discharging direction of the recording material S is a rear surface side (rear side) of the image forming apparatus 100.

### <Image Forming Operation>

Next, an image forming operation of the image forming apparatus 100 will be described by taking an image forming operation during full-color image formation as an example.

During the image formation, the photosensitive drum 1 is rotationally driven in an arrow R1 direction (counterclockwise direction) in FIG. 14 at a predetermined rotational speed (peripheral speed). Further, the driving roller 12 is rotationally driven, so that the intermediary transfer belt 11 is rotated (circulated and moved) in an arrow R2 direction (clockwise direction) in FIG. 14 at a rotational speed corresponding to the rotational speed of the photosensitive drum 1. In a contact portion between the photosensitive drum 1 and the intermediary transfer belt 11, the surface of the photosensitive drum 1 and the surface of the intermediary transfer belt 11 more in a forward direction. The stretching rollers other than the driving roller 12, and the primary transfer roller 15 are rotated with the rotation of the intermediary transfer belt 11.

Further, drive of the laser scanner unit 8 is started. In synchronism with the start of the drive, the surface of the photosensitive drum 1 is uniformly charged to a predetermined polarity (negative polarity in this embodiment) and a predetermined potential by the charging roller 2. During the charging, to the charging roller 2, a charging voltage (charging bias) of the same polarity as the charge polarity of the photosensitive drum 1 is applied. The charged surface of the photosensitive drum 1 is subjected to scanning exposure to laser light depending on an image signal of a color corresponding to each of the process units P by the laser scanner unit 8, so that the electrostatic latent image corresponding to the associated color image signal is formed on the photosensitive drum 1.

The electrostatic latent image formed on the photosensitive drum 1 is developed (visualized) by being supplied with the toner by the developing unit 5. The developing unit 5 supplies the toner to the surface of the photosensitive drum 1 by the developing roller 4 rotationally driven in the clockwise direction in FIG. 14 at a predetermined rotational speed. During development, to the developing roller 4, a developing voltage (developing bias) of the same polarity as the charge polarity of the photosensitive drum 1 is applied. By the above-described process, on the photosensitive drums 1Y, 1M, 1C, and 1K, the yellow toner, the magenta toner, the cyan toner, and the black toner are formed, respectively. The toner images formed on the photosensitive drums 1Y, 1M, 1C, and 1K are successively transferred (primarily transferred) superposedly onto the rotating intermediary transfer belt 11 in the same image forming region in the primary transfer portions N1Y, N1M, N1C, and N1K, respectively. During the primary transfer, to the primary transfer roller 15, a primary transfer voltage (primary transfer bias) of n opposite polarity (positive polarity in this embodiment) to the normal charge polarity of the toner is applied.

Thus, on the intermediary transfer belt 11, the toner images of the four colors of yellow, magenta, cyan, and black constituting the full-color image are formed. On the other hand, at a predetermined control timing, recording materials S are separated and fed one by one from the feeding tray 31 by the feeding roller 32. This recording material S is guided toward the secondary transfer portion N2 at a predetermined control timing by the registration roller pair 40. Further, in a process in which this recording material S is nipped and conveyed in the secondary transfer portion N2 by the intermediary transfer belt 11 and the secondary transfer roller 20, the toner images on the intermediary transfer belt 11 are transferred (secondary transferred) onto the recording material S. During the secondary transfer, to the secondary transfer roller 20, a secondary transfer voltage (secondary transfer bias) of the opposite polarity (positive polarity in this embodiment) to the normal charge polarity of the toner is applied. The driving roller 12 is electrically grounded (connected to the ground potential).

Further, the secondary transfer roller 20 is rotated with the rotation of the intermediary transfer belt 11.

The recording material S on which the toner image is transferred is heated and pressed by the fixing unit 50, so that the toner image is fixed (melted, stuck) on the recording material S. The recording material S on which the toner image is fixed is discharged (outputted) toward the discharge tray 70 by the discharging roller 60.

Incidentally, the image forming apparatus 100 is also capable of forming a monochromatic (single-color) image (such as a black (monochromatic) image) or a multi-color image by using a desired single or a desired plurality of process units P.

Further, the process unit P may also include a cleaning means for removing residual toner from the surface of the photosensitive drum 1. As the cleaning means, a cleaning device for accommodating a cleaning container by scraping off the toner from the surface of the rotating photosensitive drum 1 with a cleaning blade as a cleaning member.

Further, the image forming apparatus 100 may also include a cleaning means for removing residual toner from the surface of the intermediary transfer belt 11. Also, as this cleaning means, a cleaning device similar to the above-described cleaning provided can be used.

### <Outline of Toner Supply>

Next, an outline of toner supply toward the developing container 3 of the developing device 5 in this embodiment will be described.

A front surface side end portion which is one end portion of the image forming apparatus 100 with respect to the second direction is provided with a main assembly opening 121 which is an opening of the main assembly casing 120. Further, the main assembly casing 120 is provided with a front door 130 as an openable/closable member for opening and closing the main assembly opening 121. With respect to the second direction, between the process unit P and the main assembly opening 121, a cartridge holder 140 is provided. To this cartridge holder 140, toner cartridges (herein, simply referred also to as “cartridges”) 200Y, 200M, 200C, and 200K which are toner containers for supply and for the colors of yellow, magenta, cyan, and black are detachably mounted. By this, the cartridges 200Y, 200M, 200C, and 200K are detachably mounted to an apparatus main assembly 110 of the image forming apparatus 100. The cartridges 200Y, 200M, 200C, and 200K contain the yellow toner, the magenta toner, the cyan toner, and the black toner, respectively, therein. Further, to the developing containers 3Y, 3M, 3C, and 3K of the developing devices 5Y, 5M, 5C, and 5K, the yellow toner, the magenta toner, the cyan toner, and the black toner are supplied from the cartridges 200Y, 200M, 200C, and 200K, respectively. Herein, a portion obtained by excluding the cartridges 200Y, 200M, 200C, and 200K from the image forming apparatus 100 is referred to as the “apparatus main assembly 110”.

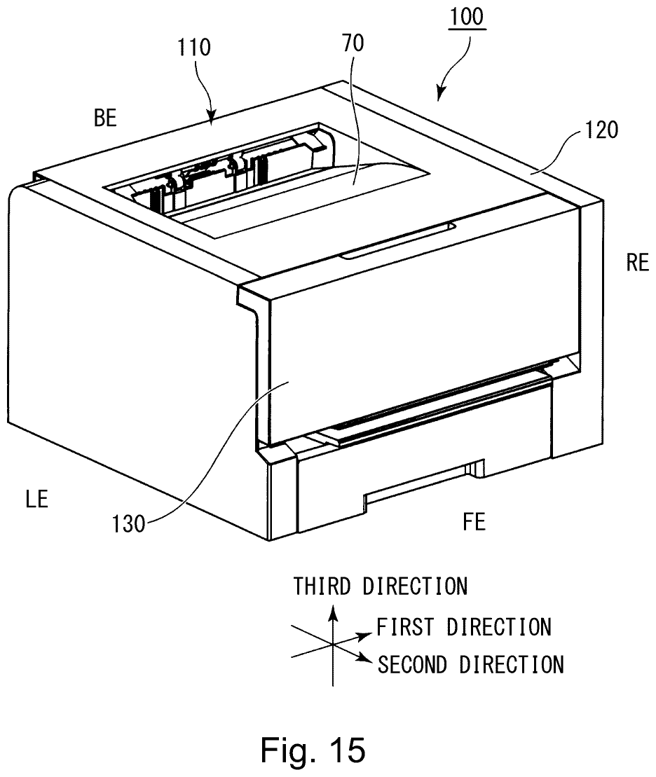

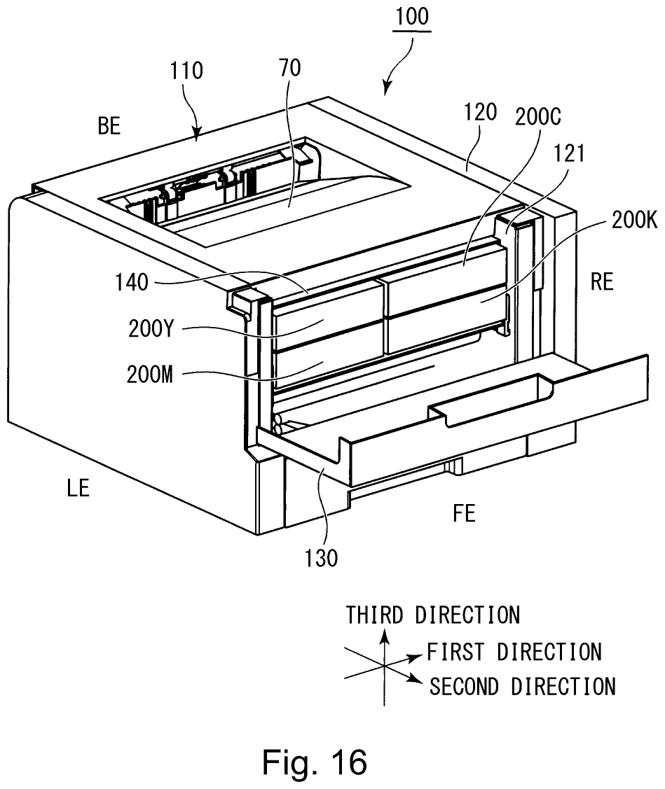

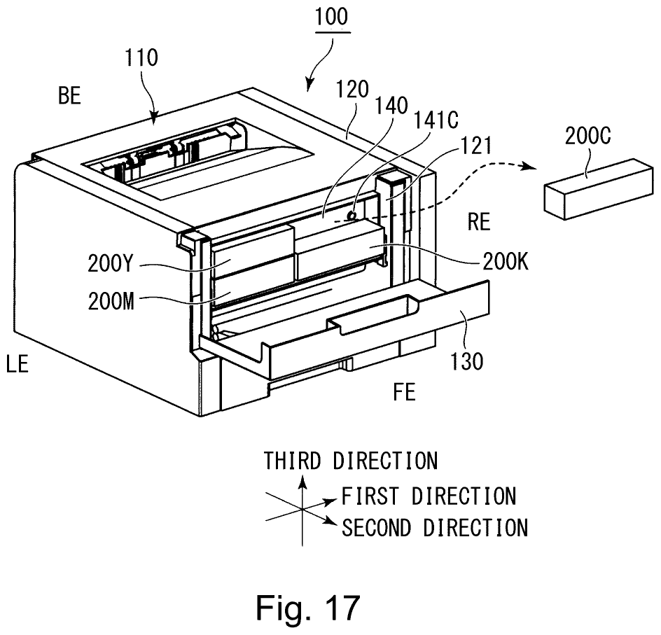

FIG. 15 is a perspective view of the image forming apparatus 100 in a state in which the front door 130 is closed. FIG. 16 is a perspective view of the image forming apparatus 100 in a state in which the front door 130 is opened. FIG. 17 is a perspective view of the image forming apparatus 100 in a state in which the cartridge 200C for cyan is demounted from the cartridge holder 140 in a state in which the front door 130 is opened.

The front door 130 is constituted so as to be movable between a closed position (FIG. 15) where the main assembly opening 121 is closed and an open position (FIGS. 16 and 17) where the main assembly opening 121 is open. In this embodiment, the front door 130 is constituted so s to be movable between the closed position and the open position by being rotated about a rotational axis positioned in a lower end portion thereof and substantially parallel to the first direction. As shown in FIGS. 16 and 17, an operator opens the front door 130 and is capable of accessing the cartridges 200. Thus, the cartridges 200 are detachably mounted to the apparatus main assembly 110 in the front surface side end portion which is one end portion of the image forming apparatus 100 with respect to the second direction. In other words, the cartridges 200 are provided in an end portion of the image forming apparatus 100 on a downstream side with respect to a discharging direction of the recording material S by the discharging roller 60.

As shown in FIG. 17, the cartridges 200 are constituted so as to be detachably mountable to the cartridge holder 140 by being moved along the second direction. By this, the operator is capable of supplying the toner to the process unit P without demounting the process unit P from the apparatus main assembly 110. Further, the cartridges 200 are disposed in the front surface side end portion of the image forming apparatus 100, whereby the operator is capable of accessing the cartridges 200 from the front surface side of the image forming apparatus 100 similarly as in the case of collection of the recording material S discharged on the discharge tray 70.

Further, as shown in FIG. 17, the image forming apparatus 100 is provided with the cartridge holder 140 in the front surface side end portion thereof, and therefore, even after the cartridge 200 is demounted, the process unit P is substantially prevented from being exposed to the outside of the image forming apparatus 100. The cartridge 200 is accommodated in the apparatus main assembly 110 in a state in which the front door 130 is closed.

Incidentally, the cartridge holder 140 may be provided with a holding means for detachably holding the cartridges 200. As the holding means, it is possible to use an arbitrary means such as a constitution in which the cartridge 200 is held by press-fitting at least a part thereof into a holding portion or a constitution in which at least a part of the cartridge 200 is locked by an elastically deformable locking portion, for example.

### <Arrangement of Toner Cartridges>

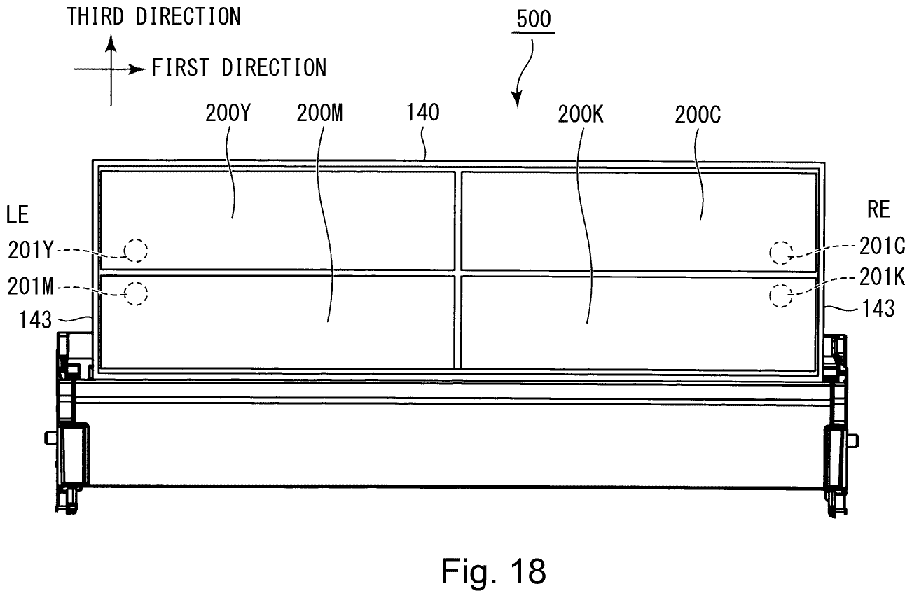

Next, with reference to FIGS. 16 to 18, arrangement of the cartridges 200Y, 200M, 200C, and 200K will be described. FIG. 18 is a front view of the cartridges 200Y, 200M, 200C, and 200K mounted to the cartridge holder 140 (an image forming unit 500 described later) as viewed in the second direction from the front surface side.

The image forming apparatus 100 includes the cartridges 200, 200M, 200C, and 200K detachably mountable to the apparatus main assembly 110. The cartridges 200Y, 200M, 200C, and 200K are disposed in the front surface side end portion of the image forming apparatus 100 with respect to the second direction.

Further, as regards each of the cartridges 200Y, 200M, 200C, and 200K, at least one end portion (one end portion in this embodiment) thereof with respect to the first direction is disposed adjacently to either one end portion of the image forming apparatus 100 with respect to the first direction.

In other words, only one end portion of each of the cartridges 200Y, 200M, 200C, and 200K with respect to the first direction is adjacent to the associated cartridge 200.

Further, the cartridge 200Y for yellow and the cartridge 200M for magenta are disposed so as to overlap with each other with respect to the third direction. Here, disposition (arrangement) such that one cartridge 200 (or a predetermined region thereof) and another cartridge 200 (or a predetermined region thereof) are disposed so as to overlap with each other with respect to the third direction specifically refers to the following disposition (arrangement). That is, in the case where these cartridges are viewed in the third direction, at least a part of the one cartridge 200 (or the predetermined region thereof) and at least a part of the another cartridge 200 (or the predetermined region thereof) overlap with each other. In this embodiment, the cartridge 200Y for yellow and the cartridge 200M for magenta in the third direction, and are disposed adjacently to each other. In this embodiment, the cartridge 200Y for yellow in disposed on an upper side, and the cartridge 200M for magenta is disposed on a lower side. Similarly, the cartridge 200C for cyan and the cartridge 200K for black are disposed so as to overlap with each other with respect to the third direction. In this embodiment, the cartridge 200C for cyan and the cartridge 200K for black are arranged in the third direction, and are disposed adjacently to each other. In this embodiment, the cartridge 200C for cyan is disposed on the upper side, and the cartridge 200K for black is disposed on the lower side.

Further, the cartridge 200Y for yellow and the cartridge 200C for cyan are disposed so as to overlap with each other with respect to the first direction. Here, disposition (arrangement) such that one cartridge 200 (or a predetermined region thereof) and another cartridge 200 (or a predetermined region thereof) are disposed so as to overlap with each other with respect to the first direction specifically refers to the following disposition (arrangement). That is, in the case where these cartridges are viewed in the first direction, at least a part of the one cartridge 200 (or the predetermined region thereof) and at least a part of the another cartridge 200 (or the predetermined region thereof) overlap with each other. In this embodiment, the cartridge 200Y for yellow and the cartridge 200C for cyan are arranged in the first direction, and are disposed adjacently to each other. In this embodiment, the cartridge 200Y for yellow is disposed on the left side surface side, and the cartridge 200C for cyan is disposed on the right side surface side. Similarly, the cartridge 200M for magenta and the cartridge 200K for black are disposed so as to convey with each other with respect to the first direction. In this embodiment, the cartridge 200M for magenta and the cartridge 200K for black are arranged in the first direction, and are disposed adjacently to each other. In this embodiment the cartridge 200M for magenta is disposed on the left side surface side, and the cartridge 200K for black is disposed on the right side surface side.

Thus, in this embodiment, the cartridge 200Y for yellow and the cartridge 200M for magenta are shifted and disposed to the end portion of the image forming apparatus 100 on the left side surface side with respect to the first direction. Further, the cartridge 200C for cyan and the cartridge 200K for black are shifted and disposed to the end portion of the image forming apparatus 100 on the right side surface side with respect to the first direction. That is, in this embodiment, the cartridge 200Y for yellow and the cartridge 200M for magenta are disposed in positions, with respect to the first direction, close to the left side surface side end portion (first end portion) than to the right side surface side end portion (second end portion) of the image forming apparatus 100. Further, the cartridge 200C for cyan and the cartridge 200K for black are disposed in positions, with respect to the first direction, closer to the right side surface side end portion (second end portion) than to the left side surface side end portion (first end portion) of the image forming apparatus 100.

Particularly, in this embodiment, the cartridges 200Y, 200M, 200C, and 200K have substantially the same outer configuration. Further, in this embodiment, in a state in which the cartridges 200 are mounted to the apparatus main assembly 110, each of the cartridges has the substantially rectangular parallelopiped shape long in the first direction. In the state in which the cartridges 200 are mounted to the apparatus main assembly 110, each cartridge 200 has a side extending along (in this embodiment, substantially parallel to) the second direction, a side extending along (in this embodiment, substantially parallel to) the second direction, and a side extending along (in this embodiment, substantially parallel to) the third direction. Further, the cartridge 200Y for yellow and the cartridge 200M for magenta are aligned and disposed along the third direction (substantially parallel to each other in this embodiment). In this embodiment, as viewed in the third direction, the cartridge 200Y for yellow and the cartridge 200M for magenta substantially entirely overlap with each other. Similarly, the cartridge 200C for cyan and the cartridge 200K for black are aligned and disposed along the third direction (substantially parallel to each other in this embodiment). In this embodiment, as viewed in the third direction, the cartridge 200C for cyan and the cartridge 200K for black substantially entirety overlap with each other. Further, the cartridge 200Y for yellow and the cartridge 200C for cyan are aligned and disposed along the first direction (substantially parallel to each other in this embodiment). In this embodiment, as viewed in the first direction, the cartridge 200Y for yellow and the cartridge 200C for cyan substantially entirety overlap with each other. Similarly, the cartridge 200M for magenta and the cartridge 200K for black are align and disposed along the first direction (substantially parallel to each other in this embodiment). In this embodiment, as viewed in the first direction, the cartridge 200M for magenta and the cartridge 200K for black substantially entirely overlap with each other.

Further, the cartridges 200Y, 200M, 200C, and 200K are provided with discharge openings 201Y, 201M, 201C, and 201K, respectively, each for permitting discharge of the toner. The discharge openings 201 are provided in end portions of the cartridges 200, with respect to the first direction, adjacent to the associated end portion of the image forming apparatus 100 with respect to the first direction (FIG. 18). Details of arrangement of the discharge openings 201 will be described later.

Incidentally, in this embodiment, the cartridges 200Y, 200M, 200C, and 200K for the colors of yellow, magenta, cyan, and black, respectively are arranged in color as described above, but color arrangement different from the color arrangement in this embodiment may also be employed.

### <Toner Conveying Path>

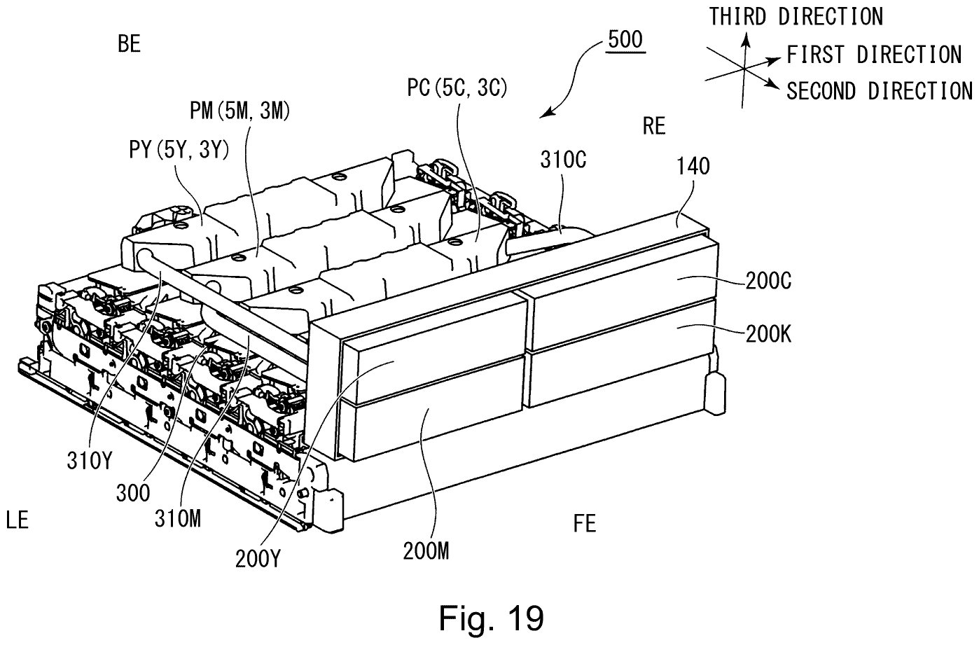

Next, with reference to FIGS. 19 to 23, a toner conveying path (toner supplying path) from the cartridges 200 toward the developing containers 3 will be described.

Here, a unit including the process units PY, PM, PC, and PK, the cartridge holder 140, the cartridges 200Y, 200M, 200C, and 200K, and a supplying mechanism 300 described later is referred to as the image forming unit 500. The supplying mechanism 300 is constituted by including supply pipes 310 (310Y, 310M, 310C, 310K) (FIGS. 19 to 23) and conveying devices 320 (320Y, 320M, 320C, 320K) (FIG. 25) which are described later.

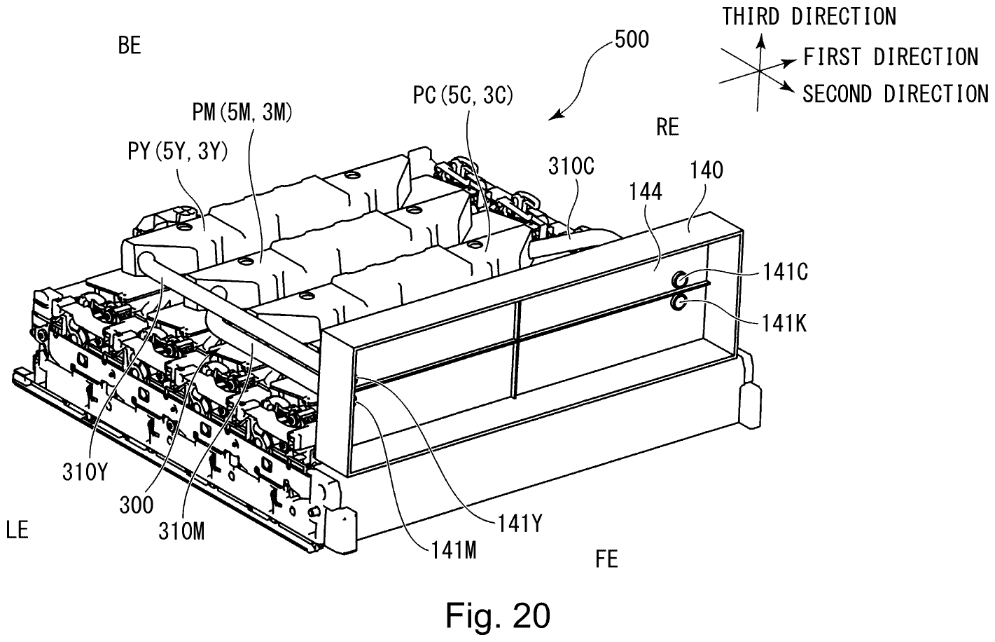

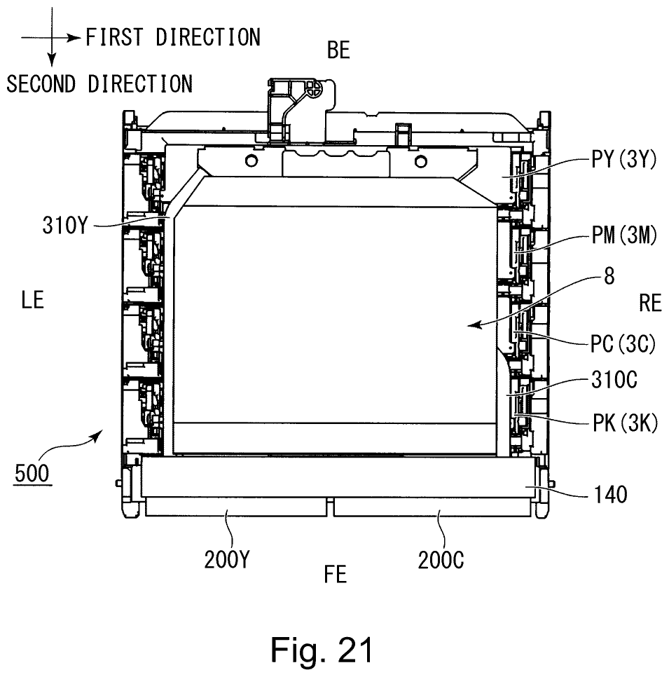

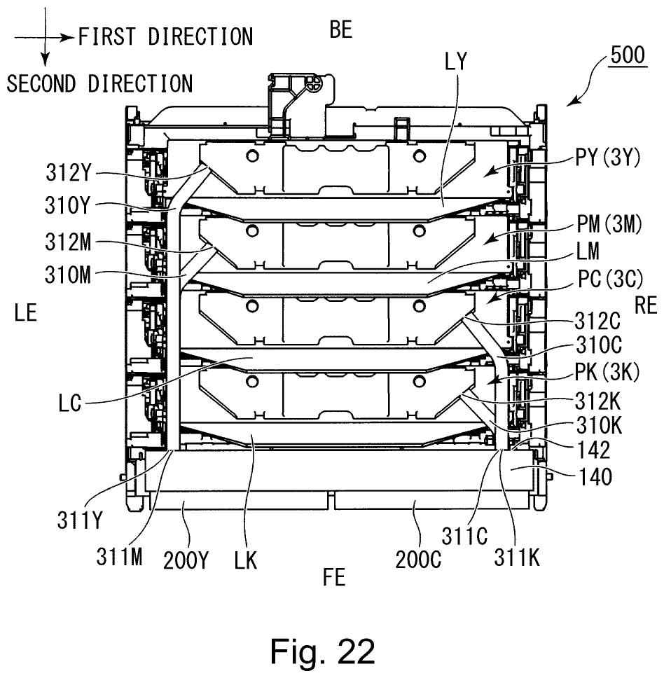

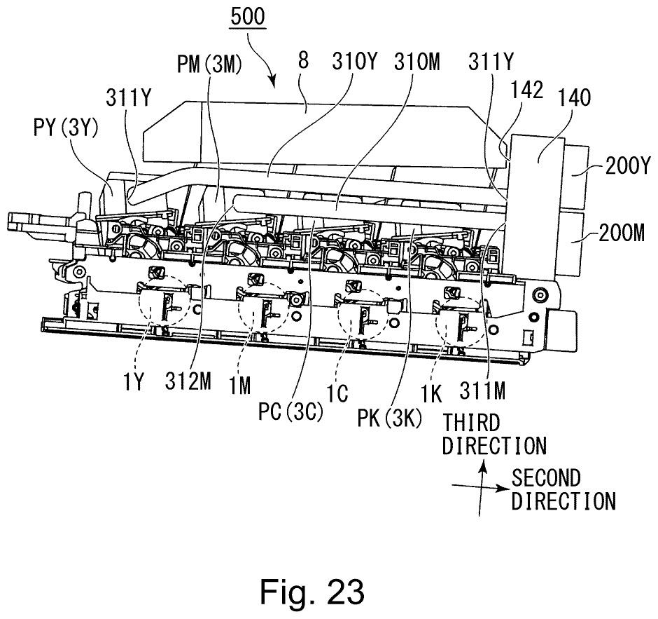

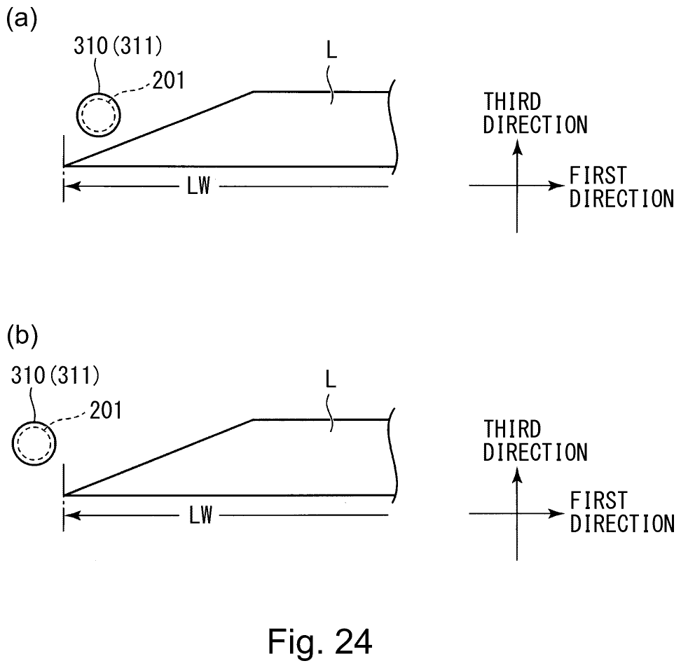

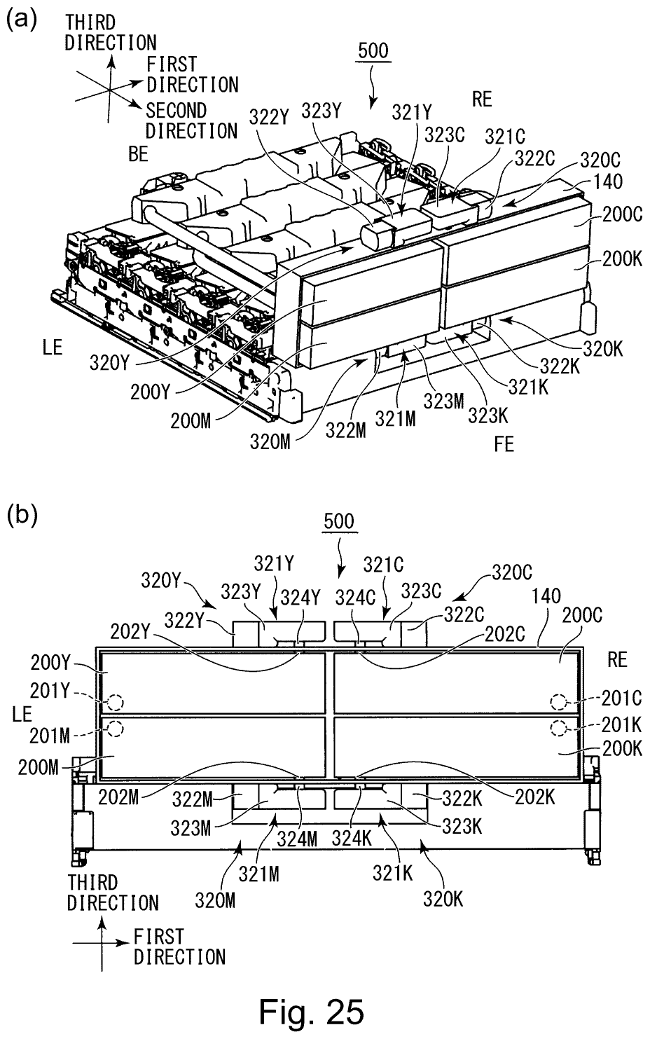

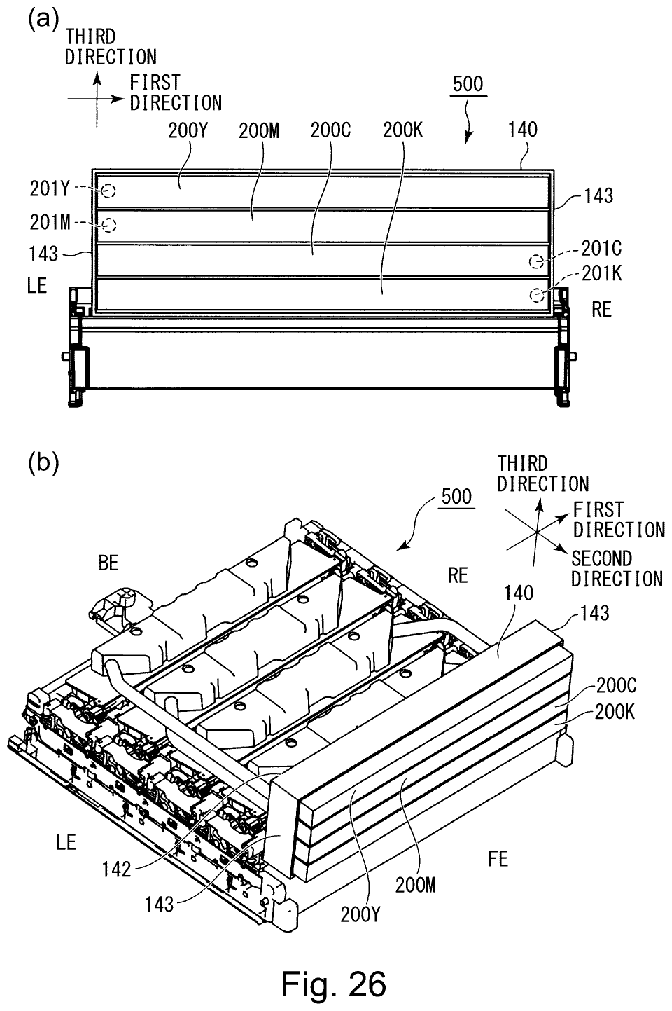

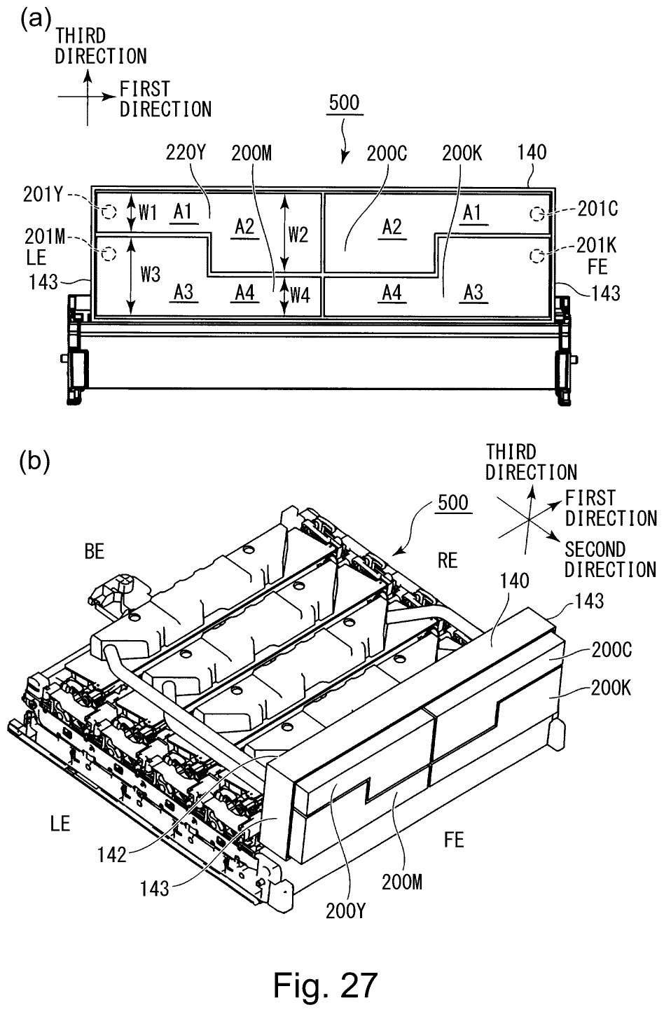

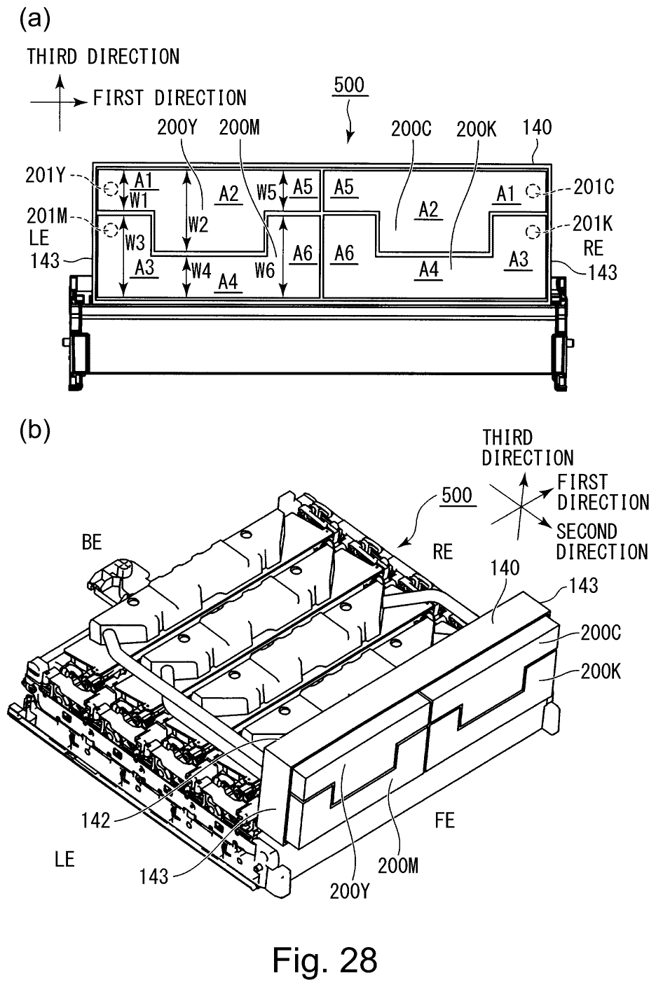

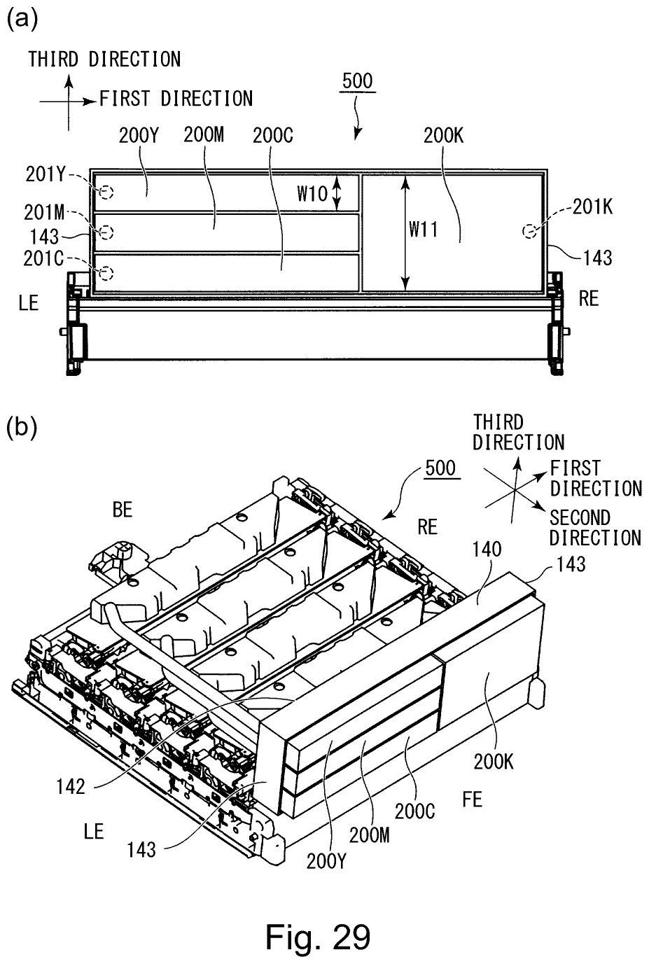

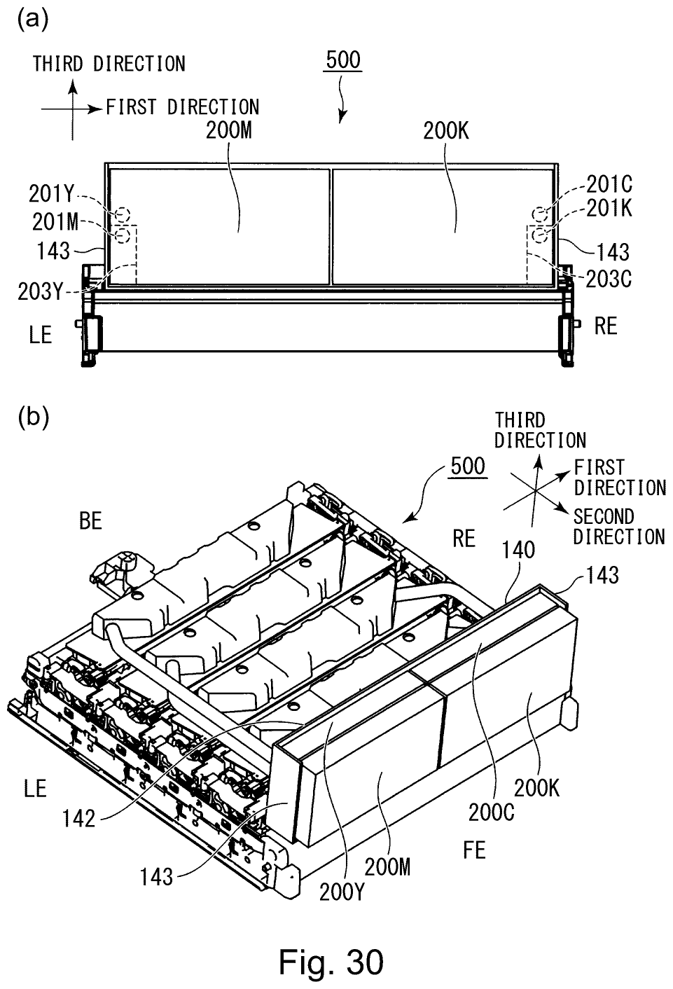

FIG. 19 is a perspective view of the image forming unit 500 in a state in which the cartridges 200Y, 200M, 200C, and 200K are mounted. FIG. 20 is a perspective view of the image forming unit 500 in a state in which the cartridges 200Y, 200M, 200C, and 200K are demounted. FIG. 21 is a plan view of the laser scanner unit 8 and the image forming unit 500 as viewed in the third direction from above. FIG. 22 is a plan view of the image forming unit 500 as viewed in the third direction from above, and in which optical paths LY, LM, LC, and LK of laser light from the laser scanner unit 8 toward the photosensitive drums 1Y, 1M, 1C, and 1K are illustrated. FIG. 23 is a side view of the laser scanner unit 8 and the image forming unit 500 as viewed in the first direction from the left side surface side.

As shown in FIG. 20, the cartridge holder 140 is provided with receiving openings 141Y, 141M, 141C, and 141K for receiving toner discharged through the discharge openings 201Y, 201M, 201C, and 201K provided to the cartridges 200Y, 200M, 200C, and 200K, respectively. A front surface side end portion of the receiving opening 141 is disposed on a side surface 144 of the cartridge holder 140 on a front surface side (FIG. 20). Further, a rear surface side end portion of the receiving opening 141 is disposed on a side surface 142 of the cartridge holder 140 on a rear surface side (FIGS. 22 and 23).

The receiving openings 141 are disposed in two positions on each of the left side surface side and the right side surface side.

The supply pipes 310Y, 310M, 310C, and 310K as paths through which the toner moved from the cartridges 200Y, 200M, 200C, and 200K toward the developing containers 3Y, 3M, 3C, and 3K are provided so as to be positioned in the main assembly casing 120. Each supply pipe 310 constitutes a toner conveying path from the cartridge 200 toward the developing container 3. An end portion of the supply pipe 310 on a cartridge 200 side (discharge opening 201 side) is an upstream end portion 311 (311Y, 311M, 311C, 311K). Further, an end portion of the supply pipe 310 on a developing container 3 side in a downstream end portion 312 (312Y, 312M, 312C, 312K).

To rear surface side end portions of the receiving openings 141Y, 141M, 141C, and 141K, the upstream end portions 311Y, 311M, 311C, and 311K of the supply pipes 310Y, 310M, 310C, and 310K are connected, respectively. By this, the receiving opening 141 and an inside of the supply pipe 310 communicate with each other so as to permit movement of the toner. Further, when the cartridges 200Y, 200M, 200C, and 200K are mounted in predetermined positions of the cartridge holder 140, the discharge openings 201Y, 201M, 201C, and 201K and the receiving openings 141Y, 141M, 141C, and 141K are connected to each other, respectively. By this, an inside of the cartridge 200 and an inside of the supply pipe 310 communicate with each other toner the discharge opening 201 and the receiving opening 141 so as to permit the movement of the toner. The downstream end portions 312Y, 312M, 312C, and 312K of the supply pipes 310Y, 310M, 310C, and 310K are connected to the developing containers 3Y, 3M, 3C, and 3K, respectively. By this, the inside of the developing container 3 and the inside of the supply pipe 310 communicate with each other so as to permit the movement of the toner.

Incidentally, the discharge opening 201 and the receiving opening 141 can be connected to each other by an arbitrary connecting means when leakage of the toner through between these openings can be sufficiently suppressed. For example, it is possible to use a constitution in which these openings are connected to each other by inserting either one of the discharge opening 201 and the receiving opening 141 into an inside of the other opening, a constitution in which these openings are connected to each other by bringing end surfaces constituting edge portions of the discharge opening 201 and the receiving opening 141 into contact with each other, or the like constitution. Further, a sealing member for suppressing leakage of the toner from a connecting portion between the discharge opening 201 and the receiving opening 141 may be provided.

The toner discharged from the inside of the cartridge 200 through the discharge opening 201 and received through the receiving opening 141 is moved inside the supply pipe 310 from the upstream end portion 311 to a downstream end portion 444, and is supplied to the inside of the developing container 3. As a conveying means for conveying the toner toward the developing container 3 through the supply pipe 310, it is possible to use a constitution in which the toner is conveyed together with air by using a pump, a constitution using a screw, a constitution using a belt conveyer, or the like constitution. An example of this conveying means will be described later.

### <Arrangement of Supply Pipes and Discharge Openings>

Next, with reference to FIGS. 19 to 24, arrangement of the supply pipes 310Y, 310M, 310C, and 310K and the discharge openings 201Y, 201M, 201C, and 201K will be described. Parts (a) and (b) of FIG. 24 are schematic views for illustrating a positional relationship between the optical path L (LY, LM, LC, LK) of the laser light and the discharge opening 201 (or the upstream end portion 311 of the supply pipe 310) as viewed in the second direction (in which only one end portion side of the optical path L with respect to the first direction is illustrated).

The supply pipes 310Y, 310M, 310C, 310K are disposed while avoiding the optical paths LY, LM, LC, and LK so as not to block the optical paths LY, LM, LC, and LK of the laser light emitted from the laser scanner unit 8 toward the photosensitive drums 1Y, 1M, 1C, and 1K during the image formation. In this embodiment, the supply pipes 310Y, 310M, 310C, and 310K (particularly, at least a part thereof including the upstream end portions 311Y, 311M, 311C, and 311K) are disposed so as not to overlap with either one of the optical paths LY, LM, LC, and LK as viewed in the second direction. Here, in this embodiment, as shown in FIG. 22, the optical path L of the laser light emitted from the laser scanner unit 8 to the photosensitive drum 1 becomes wider in width in the first direction as the optical path L approaches from the exposure window 7 of the laser scanner unit 8 toward the photosensitive drum 1. In such a constitution, as shown in FIG. 22 and part (a) of FIG. 24, at least a part of the supply pipe 310 (upstream end portion 311) with respect to the first direction may be positioned within a range LW of the optical path L. Even in this case, when the supply pipe 310 does not overlap with the optical path L as viewed in the second direction, simplification of the toner conveying path can be realized while avoiding blocking of the optical path L by the supply pipe 310. Further, by employing such a constitution, a size of the image forming apparatus 100 in the first direction is advantageously reduced. However, as shown in part (b) of FIG. 24, with respect to the first direction, the supply pipe 310 may also be positioned outside the range LW of the optical path L.

In this embodiment, with respect to the first direction, two supply pipes 310 are disposed on each of the left side surface side and the right side surface side while sandwiching the optical paths LY, LM, LC, and LK therebetween. That is, the supply pipe 310Y for yellow and the supply pipe 310M for magenta are disposed on the left side surface side, and the supply pipe 310C for cyan and the supply pipe 310K for black are disposed on the right side surface side. Further, the supply pipe 310Y for yellow and the supply pipe 310M for magenta are constituted so that at least a part of the supply pipe 310Y for yellow and at least a part of the supply pipe 310M for magenta overlap with each other as viewed in the third direction. In this embodiment, the supply pipe 310Y for yellow and the supply pipe 310M for magenta are constituted so that parts thereof at least including the upstream end portions 311Y and 311M overlap with each other as viewed in the third direction. Similarly, the supply pipe 310C for cyan and the supply pipe 310K for black are constituted so that at least a part of the supply pipe 310C for cyan and at least a part of the supply pipe 310K for black overlap with each other as viewed in the third direction. In this embodiment, the supply pipe 310C for cyan and the supply pipe 310K for black are constituted so that parts thereof at least including the upstream end portions 311C and 311K overlap with each other as viewed in the third direction.

Thus, in this embodiment, the two supply pipes 310 disposed on each of the left side surface side and the right side surface side are constituted so as to overlap with each other in at least a part thereof including the upstream end portion 311 thereof connected to the cartridge holder 140 in the case where the two supply pipes 310 are viewed in the third direction. Further, in this embodiment, each of the supply pipes 310Y, 310M, 310C, and 310K extends so that at least a part thereof including the upstream end portion 311 extends substantially linearly from the cartridge holder 140 in a position where the supply pipe avoids the optical path L as described above.

Incidentally, in this embodiment, as shown in FIGS. 21 and 23, the supply pipes 310Y, 310M, 310C, and 310K are disposed on a lower side with respect to the laser scanner unit 8. Further, in this embodiment, the supply pipes 310Y, 310M, 310C, and 310K are disposed on an upper side with respect to the photosensitive drums 1Y, 1M, 1C, and 1K. Further, in this embodiment, the two supply pipes 310Y and 310M disposed on the left side surface side are disposed by being separated upward and downward, and the two supply pipes 310C and 310K are disposed by being separated upward and downward. However, even if these supply pipes are capable of avoiding the optical paths LY, LM, LC, and LK and other peripheral component parts, the plurality of supply pipes 310 disposed on each of the left side surface side and the right side surface side may also be constituted so as to vertically overlap with each other in at least parts thereof.

Further, in order to enable the above-described arrangement of the supply pipes 310Y, 310M, 310C, and 310K, the discharge openings 201Y, 201M, 201C, 201K of the cartridges 200Y, 200M, 200C, and 200K are disposed as follows. That is, each of the discharge openings 201Y, 201M, 201C, and 201K is provided in an end portion of the associated cartridge 200, with respect to the first direction, adjacent to the associated end portion of the image forming apparatus 100 with respect to the first direction (FIG. 18).

Particularly, in this embodiment, each of the discharge openings 201Y, 201M, 201C, and 201K is disposed so as not to overlap with either one of the optical paths LY, LM, LC, and LK as viewed in the second direction (FIGS. 22 and 24). Similarly as in the case of the supply pipe 310 (upstream end portion 311), as shown in part (a) of FIG. 24, at least a part of the discharge opening 201 with respect to the first direction may be positioned within the range LW of the optical path L, and as shown in part (b) of FIG. 24, with respect to the first direction, the discharge opening 201 with respect to the first direction may be positioned outside the range LW of the optical path L.

In this embodiment, the cartridge 200Y for yellow and the cartridge 200M for magenta are disposed so as to overlap with each other with respect to the third direction, and each of left side surface side end portions thereof with respect to the first direction is disposed adjacently to the left side surface side end portion of the image forming apparatus 100. For that reason, the discharge openings 201Y and 201M of the cartridges 200Y and 200M can be disposed in the left side surface side end portions of the cartridges 200Y and 200M, respectively, adjacent to the left side surface side end portion of the image forming apparatus 100 with respect to the first direction (FIG. 18). Further, in this embodiment, the cartridge 200C for cyan and the cartridge 200K for black are disposed so as to overlap with each other with respect to the third direction, and each of right side surface side end portions thereof with respect to the first direction is disposed adjacently to the right side surface side end portion of the image forming apparatus 100. For that reason, the discharge openings 201C and 201K of the cartridges 200C and 200K can be disposed in the right side surface side end portions of the cartridges 200C and 200K, respectively, adjacent to the right side surface side end portion of the image forming apparatus 100 with respect to the first direction (FIG. 18). Thus, in this embodiment, the discharge openings 201 are disposed in two positions on each of the left side surface side and the right side surface side.

Here, as described in JP-A No. 2023-7030, in the case where if the four cartridges 200Y, 200M, 200C, and 200K are aligned and disposed in the first direction, the following arrangement is made. At least two cartridges 200 which are not adjacent to the end portions of the image forming apparatus 100 and which are disposed inside the image forming apparatus 100 are required to bypass the supply pipe 310 from the upstream end portions 311 to an outside of the optical paths once in order to avoid the optical paths LY, LM, LC, and LK.

On the other hand, in this embodiment, one end portion of each of the cartridges 200Y, 200M, 200C, and 200K with respect to the first direction is disposed adjacently to either one of the end portions of the image forming apparatus 100 with respect to the first direction. For that reason, as shown in FIGS. 9 and 11, as viewed in the second direction, the upstream end portion 311 of the supply pipe 310 can be disposed in a position where the upstream end portion 311 does not overlap with the optical path L. Accordingly, according to this embodiment, the toner conveying path from the cartridge 200 toward the developing container 3 can be simplified. For that reason, a space in the image forming apparatus 100 is effectively utilized, so that downsizing of the image forming apparatus 100 and upsizing of volume (capacity) of the cartridge 200 can be realized.

Incidentally, in this embodiment, the upstream end portion 311 of the supply pipe 310 is disposed on the side surface 142 of the cartridge holder 140 on the rear surface side (FIGS. 22 and 23), but may also be disposed on a side surface 143 of the cartridge holder 140 on the left side surface side or the right side surface side (FIG. 18). In this case, correspondingly to a position of the upstream end portion 311 of the supply pipe 310, the receiving opening 141 and the discharge opening 201 may only be required to be disposed on the left side surface side or the right side surface side.

### <Conveying Means>

Next, an example of the conveying device as a conveying means for conveying the toner from the cartridge 200 toward the developing container 3 through the supply pipe 310 will be described. Part (a) of FIG. 25 is a perspective view, of the image forming unit 500 in a state in which the cartridges 200 are mounted, for illustrating the example of the conveying device 320 (320Y, 320M, 320C, 320K). Part (b) of FIG. 25 is a front view, of the image forming unit 500 in the state in which the cartridges 200 are mounted, for illustrating the example of the conveying device 320 as viewed in the second direction from the front surface side.

The conveying device 320 in this embodiment is a conveying device of a pressure feeding type. Constitutions and operations of the conveying devices 320Y, 320M, 320C, and 320K for the colors of yellow, magenta, cyan, and black, respectively, are similar to each other. In this embodiment, the conveying device 320 is constituted by including diaphragm pumps 321 (321Y, 321M, 321C, 321K). As the diaphragm pumps 321, it is possible to use available diaphragm pumps that have an arbitrary constitution, such as well-known diaphragm pumps can be used. In this embodiment, the diaphragm pumps 321 are mounted to the cartridge holder 140. The diaphragm pumps 321 include motor units 322 (322Y, 322M, 322C, 322K) and diaphragm units 323 (323Y, 323M, 323C, 323K). The diaphragm units 323 are suction ports (not shown) for sucking air and discharge ports 324 (324Y, 324M, 324C, 324K) for permitting discharge of the air. Each of the discharge ports 324 extends to an inside of a region in which the associated cartridge 200 is mounted to the cartridge holder 140. Incidentally, to the discharge port 324 of the diaphragm pump 321, an air flow path such as a tube is connected, and the discharge port 324 may also be extended to an apparatus position in the cartridge holder 140. Further, the cartridge 200 can be appropriately provided with a groove (recessed portion) so as to avoid the tube.

The cartridges 200 are provided with air receiving ports 202 (202Y, 202M, 202C, 202K) for receiving the air, discharged through the discharge port 324, to the inside of the cartridges 200. When the cartridge 200 is mounted to the cartridge holder 140 in a predetermined position, the discharge port 324 and the air receiving port 202 are connected to each other. In order to efficiently discharge the toner, accommodated inside the cartridge 200, through the discharge opening 201, it is preferable that the air receiving port 202 is provided in an end portion of the cartridge 200 on a side opposite from the discharge opening 201.

When the toner is conveyed from the cartridge 200 toward the developing container 3 through the supply pipe 310, the diaphragm pump 321 is driven, so that the air is discharged through the discharge port 324. An operation principle of the diaphragm pump 321 is well known, so that detailed description thereof will be omitted. For example, a diaphragm (film) of the diaphragm unit 323 is moved by an eccentric shaft connected to an output shaft of the motor unit 322, so that inside pressure of the diaphragm unit 323 is changed. The diaphragm unit 323 is provided with a valve for opening and closing the suction port and a valve for opening and closing the discharge port 324. Further, these valves are opened and closed depending on a change in inside pressure of the diaphragm unit 323, so that the air sucked through the suction port is discharged through the discharge port 324. This air is received inside (sent into) the cartridge 200 through the air receiving port 202. By this, the toner is discharged together with the air through the discharge opening 201, so that the toner is supplied to the developing container 3 through the supply pipe 310. Incidentally, the developing container 3 may be provided with an air exhaust port for exhausting the air through a filter for suppressing flowing-out of the toner.

Here, the supply of the toner from the cartridge 200 to the developing container 3 may be performed at once in the case where the toner in the developing container 3 is used up or in the like case, or may also be performed successively depending on a decrease in amount of the toner in the developing container 3. Further, in the case where the toner supply is performed at once, the cartridge 200 is demounted from the apparatus main assembly 110 after the toner supply is ended, and in that state, image formation may also be carried out.

Incidentally, as described above, the conveying means for conveying the toner from the cartridge 200 to the developing container 3 is not limited to a constitution in which the toner is conveyed together with the air by using the pump.

For example, a constitution using a screw, a constitution using a belt conveyor, or the like constitution may also be used. For example, the screw is provided in the cartridge 200, and the toner can be discharged through the discharge opening 201. Further, for example, the screw is provided in the supply pipe 310, and the toner can be conveyed from the upstream end portion 311 to the downstream end portion 312 of the supply pipe 310. In the constitution using the screw, as a driving source for rotating the screw, a motor of a driving portion for driving the photosensitive drum 1 or the intermediary transfer belt 11 may be utilized, or a dedicated motor may be provided. Further, different conveying means as described above may be used appropriately in combination.

As described above, according to this embodiment, it becomes possible to simplify the toner conveying path from the cartridge 200 to the developing container 3. For that reason, a space in the image forming apparatus 100 is effectively utilized, so that downsizing of the image forming apparatus 100 and upsizing of the volume of the cartridge 200 can be realized.

Incidentally, the process unit P may be mounted in the main assembly casing 120 so that the process unit P cannot be easily mounted in and demounted from the main assembly casing 120. Or, the process unit P may also be made detachably mountable to the apparatus main assembly 110. In this case, the four process units P may be individually made detachably mountable the apparatus main assembly 110, or a plurality (which may be all) of the four process units P may be made integrally detachably mountable to the apparatus main assembly 110. Further, the image forming units 500 may be made integrally detachably mountable to the apparatus main assembly 110.

Further, in this embodiment, with respect to the second direction, the cartridges 200Y, 200M, 200C, and 200K are disposed so as not to overlap with the process units PY, PM, PC, and PK (non-overlapping with process units P).

Here, “non-overlapping with process units P” means that the cartridges 200 do not overlap with elements constituting the process units P, typically, the developing containers 3 and the drum unit frames 61 which constitute outer configurations of the process units P. However, for example, with respect to the second direction, at least a part of at least one cartridge 200 may be disposed so as to overlap with at least a part of a process cartridge P (for example, the process unit P positioned closest to the main assembly opening 121 in the second direction).

### Embodiment 4

Next, another embodiment (embodiment 4) of the present disclosure will be described. Basic constitution and operation of an image forming apparatus according to this embodiment are the same as those of the image forming apparatus of the embodiment 3. Accordingly, in the image forming apparatus of this embodiment, elements having identical or corresponding functions to those of the image forming apparatus of the embodiment 3 will be omitted from detailed description by adding thereto the same reference numerals or symbols as those in the embodiment 3.

Part (a) of FIG. 26 is a front view of the image forming unit 500 in this embodiment as viewed in the second direction from the front surface side. Further, part (b) of FIG. 26 is a perspective view of the image forming unit 500 in this embodiment.

In this embodiment, the cartridges 200Y, 200M, 200C, and 200K are disposed so as to overlap with each other with respect to the third direction. In this embodiment, each of the cartridges 200Y, 200M, 200C, and 200K is disposed so that opposite end portions thereof with respect to the first direction are adjacent to end portions of the image forming apparatus 100 with respect to the first direction. In other words, each of the cartridges 200Y, 200M, 200C, and 200K is extends in the first direction from a position adjacent to one end portion to the other end portion of the image forming apparatus 100. Particularly, in this embodiment, the cartridges 200Y, 200M, 200C, and 200K have substantially the same outer configuration (substantially rectangular parallelopiped shape long in the first direction). Further, in this embodiment, the cartridges 200Y, 200M, 200C, and 200K for yellow, magenta, cyan, and black, respectively, are aligned and disposed in this order from an upper side toward a lower side along (in this embodiment, substantially parallel to) the third direction.

Further, each of the discharge openings 201Y, 201M, 201C, and 201K is provided in an end portion, of the associated cartridge 200 with respect to the first direction, adjacent to the associated end portion of the image forming apparatus 100 with respect to the first direction. Particularly, in this embodiment, each of the discharge openings 201Y, 201M, 201C, and 201K is disposed so as not to overlap with either one of the port paths LY, LM, LC, and LK as viewed in the second direction. In this embodiment, the discharge openings 201Y and 201M of the cartridges 200Y and 200M for yellow and magenta, respectively, are disposed in left side surface side end portions of the cartridges 200Y and 200M adjacent to the left side surface side end portion of the image forming apparatus 100 with respect to the first direction. Further, in this embodiment, the discharge openings 201C and 201K of the cartridges 200C and 200K for cyan and black, respectively, are disposed in right side surface side end portions of the cartridges 200C and 200K adjacent to the right side surface side end portion of the image forming apparatus 100 with respect to the first direction. Incidentally, in this embodiment, each of the cartridges 200Y, 200M, 200C, and 200K has opposite end portions, with respect to the first direction, adjacent to the associated end portions of the image forming apparatus 100 with respect to the first direction. For that reason, the discharge openings 201Y, 201M, 201C, and 201K (and the supply pipes 310Y, 310M, 310C, and 310K) can be arbitrarily disposed on either one of the left side surface side and the right side surface side with respect to the first direction.

In the constitution of this embodiment, compared with the embodiment 3, the cartridge is thin in thickness in the third direction and is long in length in the first direction. In this embodiment, the length of the cartridge 200 in the first direction can be ensured long, and therefore, for example, in the case where the toner in the cartridge 200 is conveyed toward the discharge opening 201 by a screw or the like, conveyance of the toner is easy.

Incidentally, in this embodiment, the cartridges 200Y, 200M, 200C, and 200K for yellow, magenta, cyan, and black, respectively, are arranged as described above (color arrangement), but the color arrangement may also be a different color arrangement from this embodiment.

Further, in this embodiment, the upstream end portions 311 of the supply pipes 310 are disposed on the side surface 142 of the cartridge holder 140 on the rear surface side, but may also be disposed on the side surface 143 of the cartridge holder 140 on the left side surface side or the right side surface side with respect to the first direction. In this case, correspondingly to positions of the upstream end portions 311 of the supply pipes 310, the receiving openings 141, and the discharge openings 201 may only be required to be disposed on the left side surface side or the right side surface side.

As described above, according to this embodiment, an effect similar to the effect of the embodiment 1 can be obtained, and in addition, use of the screw or the like as the toner conveying means in the cartridge 200 becomes easy.

### Embodiment 5

Next, another embodiment (embodiment 5) of the present disclosure will be described. Basic constitution and operation of an image forming apparatus according to this embodiment are the same as those of the image forming apparatus of the embodiment 1. Accordingly, in the image forming apparatus of this embodiment, elements having identical or corresponding functions to those of the image forming apparatus of the embodiment 1 will be omitted from detailed description by adding thereto the same reference numerals or symbols as those in the embodiment 1.

Part (a) of FIG. 27 is a front view of the image forming unit 500 in this embodiment as viewed in the second direction from the front surface side. Further, part (b) of FIG. 27 is a perspective view of the image forming unit 500 in this embodiment.

In this embodiment, arrangement of the cartridges 200Y, 200M, 200C, and 200K and arrangement of the discharge openings 201Y, 201M, 201C, and 201K are substantially similar to those in the embodiment 1.

Further, in this embodiment, as viewed in the second direction, a cartridge 200Y for yellow and a cartridge 200M for magenta are disposed so as to overlap with each other in a form such that L-character shapes thereof engage with each other.

Further, the cartridge 200Y for yellow includes a first region A1 and a second region A2 with respect to the first direction. With respect to the third direction, a width of the first region A1 is a first width W1, and a width of the second region A2 is a second width W2 wider than the first width W1. Further, the cartridge 200M for magenta includes a third region 3 and a fourth region A4 with respect to the first direction. With respect to the third direction, a width of the third region A3 is a third width W3, and a width of the fourth region A4 is a fourth width W4 narrower than the third width W3. In this embodiment, the first width W1 and the fourth width W4 are substantially the same, and the second width W2 and the third width W3 are substantially the same, but these widths may also be different from each other. Further, the cartridge 200Y for yellow and the cartridge 200M for magenta are disposed in the following manner. That is, as viewed in the third direction, at least a part (in this embodiment, substantially whole part) of the first region A1 and at least a part (in this embodiment, substantially whole part) of the third region A3 overlap with each other. Further, as viewed in the third direction, at least a part (in this embodiment, substantially whole part) of the second region A2 and at least a part (in this embodiment, substantially whole part) of the fourth region A4 overlap with each other. Further, as viewed in the second direction, at least a part (in this embodiment, substantially half with respect to the third direction) of the second region 2 and at least a part (in this embodiment, substantially half with respect to the third direction) of the third region A3 overlap with each other. Further, the cartridge 200Y for yellow is provided with the discharge opening 201Y in the first region A1, and the cartridge 200M for magenta is provided with the discharge opening 201M in the third region A3.

Similarly, in this embodiment, as viewed in the second direction, the cartridge 200C for cyan and the cartridge 200K for black are disposed so as to overlap with each other so as to overlap with each other in a form such that L-character shapes thereof engage with each other. In the cartridge 200C for cyan and the cartridge 200K for black, regions with widths (W1 to W4) similar to those in the cartridge 200Y for yellow and the cartridge 200M for magenta are defined as a first region A1 to a fourth region A4, respectively. Further, the cartridge 200C for cyan is provided with a discharge opening 201C in the first region A1, and the cartridge 200K for black is provided with a discharge opening 201K in the third region A3. However, shapes of the cartridge 200C for cyan and the cartridge 200K for black, and arrangements of the discharge openings 201 of these cartridges are substantially symmetrical with respect to a plane parallel to both the second direction and the third direction. Similarly, shapes of the cartridge 200M for magenta and the cartridge 200K for black, and arrangements of the discharge openings 201 of these cartridges are substantially symmetrical with respect to a plane parallel to both the second direction and the third direction.

Accordingly, in the constitution of this embodiment, by a combination of the shapes of the cartridges 200 with the arrangements of the discharge openings 201 provided to the cartridges 200, each of the cartridges 200 cannot be mounted in a position for a different color. For that reason, the constitution of this embodiment is advantageous from the viewpoint of prevention of erroneous mounting of the cartridge 200.

Incidentally, in this embodiment, the cartridges 200Y, 200M, 200C, and 200K for yellow, magenta, cyan, and black, respectively, are arranged as described above (color arrangement), but the color arrangement may also be a different color arrangement from this embodiment.

Further, similarly as in the above-described embodiments, the upstream end portions 311 of the supply pipes 310, the receiving openings 141, and the discharge openings 201 may also be disposed on the side surface 143 of the cartridge holder 140 on the left side surface side or the right side surface side of the cartridge holder 140.

As described above, according to this embodiment, an effect similar to the effect of the embodiment 1 can be obtained, and in addition, an effect such that the prevention of erroneous mounting of the cartridge is easily realized can be obtained.

### Embodiment 6

Next, another embodiment (embodiment 6) of the present disclosure will be described. Basic constitution and operation of an image forming apparatus according to this embodiment are the same as those of the image forming apparatus of the embodiment 1. Accordingly, in the image forming apparatus of this embodiment, elements having identical or corresponding functions to those of the image forming apparatus of the embodiment 3 will be omitted from detailed description by adding thereto the same reference numerals or symbols as those in the embodiment 3.

Part (a) of FIG. 28 is a front view of the image forming unit 500 in this embodiment as viewed in the second direction from the front surface side. Further, part (b) of FIG. 28 is a perspective view of the image forming unit 500 in this embodiment.

In this embodiment, similarly as in the embodiment 5, shapes of cartridges 200 are advantageous shapes from the viewpoint of the prevention of erroneous mounting of the cartridges 200.

In this embodiment, as viewed in the second direction, a cartridge 200Y for yellow and a cartridge 200M for magenta are disposed so as to overlap with each other in a form such that uneven (recess/projection) shapes thereof engage with each other.

Further, the cartridge 200Y for yellow includes, in addition to a first region A1 and a second region A2 similar to those in the embodiment 5, a fifth region A5 positioned on a side opposite from the first region A1 with respect to the first direction while sandwiching the second region A2 therebetween. With respect to the third direction, a width of the fifth region A5 is a fifth width W5 narrower than the second width W2. In this embodiment, the fifth width W5 is substantially the same as the first width W1 but may also be different from the first width W1. Further, the cartridge 200Y for yellow includes, in addition to a second region A3 and a fourth region A4 similar to those in the embodiment 5, a sixth region A6 positioned on a side opposite from the third region A3 with respect to the first direction while sandwiching the fourth region A4 therebetween. With respect to the third direction, a width of the sixth region A6 is a sixth width W6 wider than the fourth width W4. In this embodiment, the sixth width W6 is substantially the same as the third width W3 but may also be different from the third width W3.

Further, the cartridge 200Y for yellow and the cartridge 200M for magenta are disposed in the following manner. That is, similarly as in the embodiment 5, as viewed in the third direction, at least a part (in this embodiment, substantially whole part) of the first region A1 and at least a part (in this embodiment, substantially whole part) of the third region A3 overlap with each other. Further, as viewed in the third direction, at least a part (in this embodiment, substantially whole part) of the second region A2 and at least a part (in this embodiment, substantially whole part) of the fourth region A4 overlap with each other. Further, as viewed in the second direction, at least a part (in this embodiment, substantially half with respect to the third direction) of the second region 2 and at least a part (in this embodiment, substantially half with respect to the third direction) of the third region A3 overlap with each other. Further, in this embodiment, as viewed in the third direction, at least a part (in this embodiment, substantially whole part) of the fifth region A5 and at least a part (in this embodiment, substantially whole part) of the sixth region A6 overlap with each other. Further, as viewed in the second direction, at least a part (in this embodiment, substantially half with respect to the third direction) of the second region 2 and at least a part (in this embodiment, substantially half with respect to the third direction) of the sixth region A6 overlap with each other.

Further, the cartridge 200Y for yellow is provided with the discharge opening 201Y in the first region A1, and the cartridge 200M for magenta is provided with the discharge opening 201M in the third region A3.

Similarly, in this embodiment, as viewed in the second direction, the cartridge 200C for cyan and the cartridge 200K for black are disposed so as to overlap with each other so as to overlap with each other in a form such that uneven (recess/projection) shapes thereof engage with each other. In the cartridge 200C for cyan and the cartridge 200K for black, regions with widths (W1 to W6) similar to those in the cartridge 200Y for yellow and the cartridge 200M for magenta are defined as a first region A1 to a sixth region A6, respectively. Further, the cartridge 200C for cyan is provided with a discharge opening 201C in the first region A1, and the cartridge 200K for black is provided with a discharge opening 201K in the third region A3. However, shapes of the cartridge 200C for cyan and the cartridge 200K for black, and arrangements of the discharge openings 201 of these cartridges are substantially symmetrical with respect to a plane parallel to both the second direction and the third direction. Similarly, shapes of the cartridge 200M for magenta and the cartridge 200K for black, and arrangements of the discharge openings 201 of these cartridges are substantially symmetrical with respect to a plane parallel to both the second direction and the third direction.

Accordingly, also in the constitution of this embodiment, similarly as in the embodiment 5, by a combination of the shapes of the cartridges 200 with the arrangements of the discharge openings 201 provided to the cartridges 200, each of the cartridges 200 cannot be mounted in a position for a different color. For that reason, the constitution of this embodiment is advantageous from the viewpoint of prevention of erroneous mounting of the cartridge 200.

Incidentally, in this embodiment, the cartridges 200Y, 200M, 200C, and 200K for yellow, magenta, cyan, and black, respectively, are arranged as described above (color arrangement), but the color arrangement may also be a different color arrangement from this embodiment.

Further, similarly as in the above-described embodiments, the upstream end portions 311 of the supply pipes 310, the receiving openings 141, and the discharge openings 201 may also be disposed on the side surface 143 of the cartridge holder 140 on the left side surface side or the right side surface side of the cartridge holder 140.

As described above, according to this embodiment, an effect similar to the effect of the embodiment 1 can be obtained, and in addition, similarly as in the embodiment 5, an effect such that the prevention of erroneous mounting of the cartridge is easily realized can be obtained.

### Embodiment 7

Next, another embodiment (embodiment 7) of the present disclosure will be described. Basic constitution and operation of an image forming apparatus according to this embodiment are the same as those of the image forming apparatus of the embodiment 1. Accordingly, in the image forming apparatus of this embodiment, elements having identical or corresponding functions to those of the image forming apparatus of the embodiment 3 will be omitted from detailed description by adding thereto the same reference numerals or symbols as those in the embodiment 3.

Part (a) of FIG. 29 is a front view of the image forming unit 500 in this embodiment as viewed in the second direction from the front surface side. Further, part (b) of FIG. 29 is a perspective view of the image forming unit 500 in this embodiment.

In this embodiment, the cartridge 200Y for yellow, the cartridge 200M for magenta and the cartridge 200C for cyan are disposed so as to overlap with each other with respect to the third direction. These cartridges 200Y, 200M, and 200C are shifted and disposed to the end portion of the image forming apparatus 100 on the left side surface side with respect to the first direction. That is, in this embodiment, the cartridges 200Y, 200M, and 200C for yellow, magenta, and cyan, respectively, are disposed in positions, with respect to the first direction, closer to the end portion (first end portion) of the image forming apparatus 100 on the left side surface side than to an end portion (second end portion) of the image forming apparatus 100 on the right side surface side. In this embodiment, the cartridges 200Y, 200M, and 200C for yellow, magenta, and cyan, respectively, are aligned and disposed in this order align (in this embodiment, substantially parallel to) the third direction from an upper side toward a lower side. Further, the cartridge 200K for black is disposed on a side opposite from the cartridges 200Y, 200M, and 200K for other colors with respect to the first direction. In other words, the cartridge 200K for black is shifted and disposed to the end portion of the image forming apparatus 100 on the right side surface side with respect to the first direction. That is, in this embodiment, the cartridge 200K for black is disposed in a position, with respect to the first direction, closer to the end portion (second end portion) of the image forming apparatus 100 on the right side surface side than to the end portion (first end portion) of the image forming apparatus 100 on the left side surface side. Further, three cartridges 200Y, 200M, and 200C for yellow, magenta, and cyan, respectively, and the cartridge 200K for black are disposed so as to overlap with each other with respect to the first direction. For that reason, a width W11 of the cartridge 200K for black in the third direction can be made wider than a width W10 of each of the cartridges 200Y, 200M, and 200K for other colors in the third direction.

In the constitution of this embodiment, in general, a toner accommodating volume of the cartridge 200K for black large in toner consumption amount compared with yellow, magenta, and cyan can be easily made larger than a toner accommodating volume of each of the cartridges 200Y, 200M, and 200C for yellow, magenta, and cyan, respectively. Further, the above-described arrangement of the cartridges becomes an arrangement such that a user or the like intuitively distinguish between the three cartridges 200Y, 200M, 200C for yellow, magenta, and cyan, respectively, and the cartridge 200K for black easily.

Incidentally, as regards the yellow, the magenta, and the cyan, a color arrangement different from the color arrangement in this embodiment may also be employed. The three cartridges 200 may be disposed on the end portion side of the right side surface side of the image forming apparatus 100, and the one cartridge 200 may be disposed on the end portion side of the left side surface side of the image forming apparatus 100.

Further, similarly as in the above-described embodiments, the upstream end portions 311 of the supply pipes 310, the receiving openings 141, and the discharge openings 201 may also be disposed on the side surface 143 of the cartridge holder 140 on the left side surface side or the left side surface side with respect to the first direction.

As described above, according to this embodiment, an effect similar to the effect of the embodiment 1, and in addition, an increase in toner accommodating volume of the cartridge 200 for black or the like large in toner consumption amount compared with other colors in general can be realized.

### Embodiment 8

Next, another embodiment (embodiment 8) of the present disclosure will be described. Basic constitution and operation of an image forming apparatus according to this embodiment are the same as those of the image forming apparatus of the embodiment 1. Accordingly, in the image forming apparatus of this embodiment, elements having identical or corresponding functions to those of the image forming apparatus of the embodiment 1 will be omitted from detailed description by adding thereto the same reference numerals or symbols as those in the embodiment 1.

Part (a) of FIG. 30 is a front view of the image forming unit 500 in this embodiment as viewed in the second direction from the front surface side. Further, part (b) of FIG. 30 is a perspective view of the image forming unit 500 in this embodiment.

In this embodiment, the cartridge 200Y for yellow and the cartridge 200M for magenta are disposed so as to overlap with each other with respect to the second direction. Here, disposition (arrangement) such that one cartridge and another cartridge are disposed so as to overlap with each other with respect to the third direction refers to that in the case where these cartridges are viewed in the second direction, at least a part of the one cartridge and at least a part of the another cartridge overlap with each other. In this embodiment, the cartridge 200Y for yellow and the cartridge 200M for magenta in the second direction, and are disposed adjacently to each other. In this embodiment, the cartridge 200Y for yellow in disposed on a rear surface side, and the cartridge 200M for magenta is disposed on a front surface side. Similarly, in this embodiment, the cartridge 200C for cyan and the cartridge 200K for black are disposed so as to overlap with each other with respect to the second direction. In this embodiment, the cartridge 200C for cyan and the cartridge 200K for black are arranged in the second direction, and are disposed adjacently to each other. In this embodiment, the cartridge 200C for cyan is disposed on the rear surface side, and the cartridge 200K for black is disposed on the front surface side.

Further, the cartridge 200Y for yellow and the cartridge 200C for cyan are disposed so as to overlap with each other with respect to the first direction. In this embodiment, the cartridge 200Y for yellow and the cartridge 200C for cyan are arranged in the first direction, and are disposed adjacently to each other. In this embodiment, the cartridge 200Y for yellow is disposed on the left side surface side, and the cartridge 200C for cyan is disposed on the right side surface side. Similarly, the cartridge 200M for magenta and the cartridge 200K for black are disposed so as to convey with each other with respect to the first direction. In this embodiment, the cartridge 200M for magenta and the cartridge 200K for black are arranged in the first direction, and are disposed adjacently to each other. In this embodiment the cartridge 200M for magenta is disposed on the left side surface side, and the cartridge 200K for black is disposed on the right side surface side.

Particularly, in this embodiment, the cartridges 200Y, 200M, 200C, and 200K have substantially the same outer configuration. Further, the cartridge 200Y for yellow and the cartridge 200M for magenta are aligned and disposed along the second direction (substantially parallel to each other in this embodiment). In this embodiment, as viewed in the second direction, the cartridge 200Y for yellow and the cartridge 200M for magenta substantially entirely overlap with each other. Similarly, the cartridge 200C for cyan and the cartridge 200K for black are aligned and disposed along the second direction (substantially parallel to each other in this embodiment). In this embodiment, as viewed in the second direction, the cartridge 200C for cyan and the cartridge 200K for black substantially entirety overlap with each other. Further, the cartridge 200Y for yellow and the cartridge 200C for cyan are aligned and disposed along the first direction (substantially parallel to each other in this embodiment). In this embodiment, as viewed in the first direction, the cartridge 200Y for yellow and the cartridge 200C for cyan substantially entirety overlap with each other. Similarly, the cartridge 200M for magenta and the cartridge 200K for black are align and disposed along the first direction (substantially parallel to each other in this embodiment). In this embodiment, as viewed in the first direction, the cartridge 200M for magenta and the cartridge 200K for black substantially entirely overlap with each other. Also, in this embodiment, each of the discharge openings 201Y, 201M, and 201C is provided in an end portion of the cartridge 200, with respect to the first direction, adjacent to the associated end portion of the image forming apparatus 100 with respect to the first direction.

Particularly, in this embodiment, each of the discharge openings 201Y, 201M, and 201C is disposed so as not to overlap with either one of the port paths LY, LM, LC, and LK as viewed in the second direction. In this embodiment, the discharge openings 201Y and 201M of the cartridges 200Y and 200M for yellow and magenta, respectively, are disposed in left side surface side end portions of the cartridges 200Y and 200M adjacent to the left side surface side end portion of the image forming apparatus 100 with respect to the first direction. Further, in this embodiment, the discharge openings 201C and 201K of the cartridges 200C and 200K for cyan and black, respectively, are disposed in right side surface side end portions of the cartridges 200C and 200K, respectively, adjacent to the right side surface side end portion of the image forming apparatus 100 with respect to the first direction.

The constitution of this embodiment is advantageous from viewpoints of the constitution of the apparatus main assembly 110 and usability in the case where a constitution in which the cartridges 200 are mounted and demounted along the third direction is employed.

Here, in the constitution of this embodiment, as shown in part (a) of FIG. 30, in the case where the discharge openings 201 are provided on a surface opposing the rear surface side of the cartridge holder 140, the following constitution may only be required to be employed. The cartridges 200Y and 200C disposed on the rear surface side with respect to the second direction are partially provided with cut-away portions 203Y, 203C, respectively, so as not to inhibit toner conveying paths of the cartridges 200M and 200K disposed on the front surface side with respect to the second direction.

Incidentally, in this embodiment, the cartridges 200Y, 200M, 200C, and 200K for yellow, magenta, cyan, and black, respectively, are arranged as described above (color arrangement), but the color arrangement may also be a different color arrangement.

Further, similarly as in the above-described embodiments, the upstream end portions 311 of the supply pipes 310, the receiving openings 141, and the discharge openings 201 may be disposed on the side surface 143 of the cartridge holder 140 on the left side surface side or the right side surface side with respect to the first direction.

Further, also in the constitution in which the cartridges 200 overlap with each other with respect to the second direction, similarly as in the embodiment 4, opposite end portions of each of the cartridges 200 for yellow, magenta, cyan, and black may be disposed adjacently to opposite end portions of the image forming apparatus 100 with respect to the first direction. Further, the cartridges 200 for yellow, magenta, cyan, and black can be disposed so as to overlap with each other with respect to the second direction. Further, also in the constitution in which the cartridges 200 overlap with each other with respect to the second direction, similarly as in the embodiment 7, for example, three cartridges 200 may be disposed so as to overlap with each other on one end portion side of the image forming apparatus 100 with respect to the first direction, and one cartridge 200 may be disposed on the other end portion side of the image forming apparatus 100 with respect to the first direction.

As described above, according to this embodiment, an effect similar to the effect of the embodiment 1 can be obtained, and in addition, an effect such that a constitution in which the cartridges 200 are mounted and demounted along the third direction is easily employed can be obtained.

In the above-described embodiments, the image forming apparatus employed the intermediary transfer type, but the present disclosure is not limited thereto. The image forming apparatus may also be an image forming apparatus employing, for example, a direct transfer type in which toner images are successively transferred from a plurality of photosensitive drums onto a recording material carried on a recording material carrying member (recording material conveyor belt or the like).

Further, the developer for supply to be supplied from the cartridge to the developing container may also be a so-called two-component developer including the toner and a carrier.

Further, although omitted from description, also in the embodiments 4 to 8, the conveying means similar to the conveying means described in the embodiment 1 can be used. In this case, depending on the arrangement of the cartridges, positions of the discharge ports and the air receiving ports may only be required to be appropriately changed.

Further, in the above-described embodiments, the image forming apparatus was provided with the four toner cartridges and the four process units, but the numbers of the toner cartridges and the process units are not limited thereto and are appropriately set as needed. The number of the cartridges provided detachably mountable to the image forming apparatus is not limited to four, but may also be five or more (for example, six) and may also be three or less (for example, three).

By the embodiments 3 to 8, the following constitution examples are capable of being employed.

### Constitution Example 1

An image forming apparatus comprising:
a main assembly including a first photosensitive drum rotatable about a front rotational axis extending in a first direction; a first developing unit including a first developing container for accommodating first toner supplied to the first photosensitive drum and a first developing roller for carrying the first toner accommodated in the first developing container; a second photosensitive drum rotatable about a second rotational axis extending in the first direction; and a second developing unit including a second developing container for accommodating second toner supplied to the second photosensitive drum and a second developing roller for carrying the second toner accommodated in the second developing container;
a first cartridge detachably mountable to the main assembly and accommodating the first toner, the first cartridge being provided with a first discharge opening for permitting discharge of the first toner toward the first developing container; and
a second cartridge detachably mountable to the main assembly and accommodating the second toner, the second cartridge being provided with a second discharge opening for permitting discharge of the second toner toward the second developing container,
wherein the first developing unit and the second developing unit are disposed so as to be aligned in a second direction perpendicular to the first direction,
wherein the first cartridge and the second cartridge are provided in one end portion of the image forming apparatus with respect to the second direction,
wherein as viewed in a third direction perpendicular to both the first direction and the second direction, at least a part of the second cartridge is disposed so as to be overlap with the first cartridge,
wherein in a case where one end portion and the other end portion of the image forming apparatus with respect to the first direction are a first end portion and a second end portion, respectively,
with respect to the first direction, one end portion of the first cartridge is provided on a side of the first end portion of the image forming apparatus, and the first discharge opening is provided in the end portion of the first cartridge positioned on the side of the first end portion of the image forming apparatus, and
wherein the first direction, one end portion of the second cartridge is provided on a side of the first end portion of the image forming apparatus, and the second discharge opening is provided in the end portion of the second cartridge positioned on the side of the first end portion of the image forming apparatus.

### Constitution Example 2

The image forming apparatus according to Constitution example 1, wherein with respect to the first direction, the first cartridge and the second cartridge are disposed in positions closer to the first end portion than to the second end portion of the image forming apparatus.

### Constitution Example 3

The image forming apparatus according to Constitution example 1 or 2, further comprising a laser scanner,
wherein as viewed in the second direction, the first discharge opening and the second discharge opening are provided so as not to overlap with an optical path of laser light from the laser scanner toward the first photosensitive drum and an optical path of laser light from the laser scanner toward the second photosensitive drum, respectively.

### Constitution Example 4

The image forming apparatus according to Constitution example 3, further comprising:
a first path through which the first toner discharged through the first discharge opening and moved toward the first developing container passes; and
a second path through which the second toner discharged through the second discharge opening and moved toward the second developing container passes,
wherein as viewed in the second direction, an end portion of the first path on the side of the first discharge opening and an end portion of the second path on the side of the second discharge opening are disposed so as not to overlap with the optical path of the laser light from the laser scanner toward the first photosensitive drum and the optical path of the laser light from the laser scanner toward the second photosensitive drum, respectively.

### Constitution Example 5

The image forming apparatus according to Constitution example 1 or 2, wherein the first cartridge is provided with a first air receiving port through which air is received,
wherein the second cartridge is provided with a second air receiving port through which the air is received, and
wherein the image forming apparatus includes
a first pump for sending the air to the first cartridge through the first air receiving port;
a second pump for sending the air to the second cartridge through the second air receiving port;
a first path through which the first toner discharged through the first discharge opening by the air received toner the first air receiving port and moved toward the first developing container passes, and
a second path through which the second toner discharged through the second discharge opening by the air received through the second air receiving port and moved toward the second developing container passes.

### Constitution Example 6

The image forming apparatus according to Constitution example 2, wherein the main assembly includes a third photosensitive drum rotatable about a third rotational axis extending in the first direction, a developing unit including a third developing container for accommodating third toner supplied to the third photosensitive drum and a third developing roller for carrying the third toner accommodated in the third developing container, a fourth photosensitive drum rotatable about a fourth rotational axis extending in the first direction, and a fourth developing unit including a fourth developing container for accommodating fourth toner supplied to the fourth photosensitive drum and a fourth developing roller for carrying the fourth toner accommodated in the fourth developing container,
wherein the image forming apparatus further comprises
a third cartridge detachably mountable to the main assembly and accommodating the third toner, the third cartridge being provided with a third discharge opening for permitting discharge of the third toner toward the third developing container, and
a fourth cartridge detachably mountable to the main assembly and accommodating the fourth toner, the fourth cartridge being provided with a fourth discharge opening for permitting discharge of the fourth toner toward the fourth developing container,
wherein the first developing unit, the second developing unit, the third developing unit, and the fourth developing unit are disposed so as to be aligned in the second direction,
wherein the third cartridge and the fourth cartridge are disposed in the one end portion of the image forming apparatus with respect to the second direction,
wherein as viewed in the third direction, the fourth cartridge is provided so that at least a part thereof overlaps with the third cartridge,
wherein with respect to the first direction, the third cartridge and the fourth cartridge are provided in positions closer to the second end portion than to the first end portion of the image forming apparatus, and
wherein with respect to the first direction, the third discharge opening is provided in an end portion of the third cartridge on a side of the second end portion of the image forming apparatus, and the fourth discharge opening is provided in an end portion of the fourth cartridge on the side of the second end portion of the image forming apparatus.

### Constitution Example 7

The image forming apparatus according to Constitution example 6, wherein as viewed in the first direction, the third cartridge is disposed so that at least a part thereof overlaps with the first cartridge. and
wherein as viewed in the first direction, the fourth cartridge is disposed so that at least a part thereof overlaps with the second cartridge.

### Constitution Example 8

The image forming apparatus according to Constitution example 6 to 7, further comprising a laser scanner,
wherein as viewed in the second direction, the first discharge opening, the second discharge opening, the third discharge opening, and the fourth discharge opening are provided so as not to overlap with optical paths of laser light from the laser scanner toward the first photosensitive drum, the second photosensitive drum, the third photosensitive drum, and the fourth photosensitive drum, respectively.

### Constitution Example 9

The image forming apparatus according to Constitution example 8, further comprising:
a first path through which the first toner discharged through the first discharge opening and moved toward the first developing container passes;
a second path through which the second toner discharged through the second discharge opening and moved toward the second developing container passes;
a third path through which the third toner discharged through the third discharge opening and moved toward the third developing container passes; and
a fourth path through which the fourth toner discharged through the fourth discharge opening and moved toward the fourth developing container passes,
wherein as viewed in the second direction, an end portion of the first path on the side of the first discharge opening, an end portion of the second path on the side of the second discharge opening, an end portion of the third path on the side of the third discharge opening, and an end portion of the fourth path on the side of the fourth discharge opening are disposed so as not to overlap with the optical paths of the laser light from the laser scanner toward the first photosensitive drum, the second photosensitive drum, the third photosensitive drum, and the fourth photosensitive drum, respectively.

### Constitution Example 10

The image forming apparatus according to Constitution example 6 or 7, wherein the first cartridge is provided with a first air receiving port through which air is received,
wherein the second cartridge is provided with a second air receiving port through which the air is received,
wherein the third cartridge is provided with a third air receiving port through which the air is received,
wherein the fourth cartridge is provided with a fourth air receiving port through which the air is received, and
wherein the image forming apparatus includes
a first pump for sending the air to the first cartridge through the first air receiving port;
a second pump for sending the air to the second cartridge through the second air receiving port;
a third pump for sending the air to the third cartridge through the third air receiving port;
a fourth pump for sending the air to the fourth cartridge through the fourth air receiving port;
a first path through which the first toner discharged through the first discharge opening by the air received through the first air receiving port and moved toward the first developing container passes;
a second path through which the second toner discharged through the second discharge opening by the air received through the second air receiving port and moved toward the second developing container passes;
a third path through which the third toner discharged through the third discharge opening by the air received through the third air receiving port and moved toward the third developing container passes; and
a fourth path through which the fourth toner discharged through the fourth discharge opening by the air received through the fourth air receiving port and moved toward the fourth developing container passes.

### Constitution Example 11

The image forming apparatus according to Constitution example 1, wherein with respect to the first direction, the one end portion of the first cartridge is disposed on the side of the first end portion of the image forming apparatus, and the other end portion of the first cartridge is disposed on a side of the second end portion of the image forming apparatus, and
wherein with respect to the first direction, the one end portion of the second cartridge is disposed on the side of the first end portion of the image forming apparatus, and the other end portion of the second cartridge is disposed on the side of the second end portion of the image forming apparatus.

### Constitution Example 12

The image forming apparatus according to Constitution example 2, wherein the main assembly includes a third photosensitive drum rotatable about a third rotational axis extending in the first direction, a third developing unit including a third developing container for accommodating third toner supplied to the third photosensitive drum and a third developing roller for carrying the third toner accommodated in the third developing container,
wherein the image forming apparatus further comprises
a third cartridge detachably mountable to the main assembly and accommodating the third toner, the third cartridge being provided with a third discharge opening for permitting discharge of the third toner toward the third developing container,
wherein the first developing unit, the second developing unit, the third developing unit, and the fourth developing unit are disposed so as to be aligned in the second direction,
wherein the third cartridge is disposed in the one end portion of the image forming apparatus with respect to the second direction,
wherein as viewed in the third direction, the third cartridge is provided so that at least a part thereof overlaps with the first cartridge and so that at least a part thereof overlaps with the second cartridge,
wherein with respect to the first direction, the third cartridge is provided in a position closer to the second end portion than to the first end portion of the image forming apparatus, and
wherein with respect to the first direction, the third discharge opening is provided in an end portion of the third cartridge on a side of the second end portion of the image forming apparatus.

### Constitution Example 13

The image forming apparatus according to Constitution example 12, wherein an accommodating volume of the third toner of the third cartridge is larger than an accommodating volume of the first toner of the first cartridge, and is larger than an accommodating volume of the second toner of the second cartridge.

### Constitution Example 14

The image forming apparatus according to Constitution example 1 or 2, wherein the first cartridge includes a first region and a second region with respect to the first direction, and with respect to the third direction, a width of the first region is a first width and a width of the second region is a second width wider than the first width,
wherein the second cartridge includes a third region and a fourth region with respect to the first direction, and with respect to the third direction, a width of the third region is a third width and a width of the fourth region is a fourth width narrower than the third width, and
wherein as viewed in the third direction, at least a part of the third region is disposed so as to overlap with the first region and at least a part of the fourth region is disposed so as to overlap with the second region, and as viewed in the second direction, at least a part of the third region is disposed so as to overlap with the second region.

### Constitution Example 15

The image forming apparatus according to Constitution example 14, wherein with respect to the first direction, the first cartridge includes a fifth region positioned on a side opposite from the first region while sandwiching the second region therebetween, and with respect to the third direction, a width of the fifth region is a fifth width narrower than the second width,
wherein with respect to the first direction, the second cartridge includes a sixth region positioned on a side opposite from the third region while sandwiching the fourth region therebetween, and with respect to the third direction, a width of the sixth region is a sixth width wider than the fourth width, and
wherein as viewed in the third direction, at least a part of the sixth region is disposed so as to overlap with the fifth region, and as viewed in the second direction, at least a part of the sixth region is disposed so as to overlap with the second region.

### Constitution Example 16

An image forming apparatus comprising:
a main assembly including a first photosensitive drum rotatable about a front rotational axis extending in a first direction; a first developing unit including a first developing container for accommodating first toner supplied to the first photosensitive drum and a first developing roller for carrying the first toner accommodated in the first developing container; a second photosensitive drum rotatable about a second rotational axis extending in the first direction; and a second developing unit including a second developing container for accommodating second toner supplied to the second photosensitive drum and a second developing roller for carrying the second toner accommodated in the second developing container;
a first cartridge detachably mountable to the main assembly and accommodating the first toner, the first cartridge being provided with a first discharge opening for permitting discharge of the first toner toward the first developing container; and
a second cartridge detachably mountable to the main assembly and accommodating the second toner, the second cartridge being provided with a second discharge opening for permitting discharge of the second toner toward the second developing container,
wherein the first developing unit and the second developing unit are disposed so as to be aligned in a second direction perpendicular to the first direction,
wherein the first cartridge and the second cartridge are provided in one end portion of the image forming apparatus with respect to the second direction so as not to overlap with either one of the first developing unit and the second developing unit,
wherein as viewed in the second direction, at least a part of the second cartridge is disposed so as to be overlap with the first cartridge,
wherein in a case where one end portion and the other end portion of the image forming apparatus with respect to the first direction are a first end portion and a second end portion, respectively,
with respect to the first direction, one end portion of the first cartridge is provided on a side of the first end portion of the image forming apparatus, and the first discharge opening is provided in the end portion of the first cartridge positioned on the side of the first end portion of the image forming apparatus, and
wherein the first direction, one end portion of the second cartridge is provided on a side of the first end portion of the image forming apparatus, and the second discharge opening is provided in the end portion of the second cartridge positioned on the side of the first end portion of the image forming apparatus.

### Constitution Example 17

The image forming apparatus according to Constitution example 16,
wherein with respect to the first direction, the first cartridge and the second cartridge are disposed in positions closer to the first end portion than to the second end portion of the image forming apparatus.

### Constitution Example 18

The image forming apparatus according to Constitution example 17, wherein the main assembly includes a third photosensitive drum rotatable about a third rotational axis extending in the first direction, a third developing unit including a third developing container for accommodating third toner supplied to the third photosensitive drum and a third developing roller for carrying the third toner accommodated in the third developing container, a fourth photosensitive drum rotatable about a fourth rotational axis extending in the first direction, and a fourth developing unit including a fourth developing container for accommodating fourth toner supplied to the fourth photosensitive drum and a fourth developing roller for carrying the fourth toner accommodated in the fourth developing container,
wherein the image forming apparatus further comprises
a third cartridge detachably mountable to the main assembly and accommodating the third toner, the third cartridge being provided with a third discharge opening for permitting discharge of the third toner toward the third developing container, and
a fourth cartridge detachably mountable to the main assembly and accommodating the fourth toner, the fourth cartridge being provided with a fourth discharge opening for permitting discharge of the fourth toner toward the fourth developing container,
wherein the first developing unit, the second developing unit, the third developing unit, and the fourth developing unit are disposed so as to be aligned in the second direction,
wherein the first cartridge, the second cartridge, the third cartridge and the fourth cartridge are disposed in the one end portion of the image forming apparatus so as not to overlap with either one of the first developing unit, the second developing unit, the third developing unit, and the fourth developing unit with respect to the second direction,
wherein as viewed in the second direction, the fourth cartridge is provided so that at least a part thereof overlaps with the third cartridge,
wherein with respect to the first direction, the third cartridge and the fourth cartridge are provided in positions closer to the second end portion than to the first end portion of the image forming apparatus, and
wherein with respect to the first direction, the third discharge opening is provided in an end portion of the third cartridge on a side of the second end portion of the image forming apparatus, and the fourth discharge opening is provided in an end portion of the fourth cartridge on the side of the second end portion of the image forming apparatus.

### Constitution Example 19

The image forming apparatus according to Constitution example 18, wherein as viewed in the first direction, the third cartridge is disposed so that at least a part thereof overlaps with the first cartridge. and
wherein as viewed in the first direction, the fourth cartridge is disposed so that at least a part thereof overlaps with the second cartridge.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2024-146055 filed on Aug. 27, 2024, and 2024-146056, filed on Aug. 27, 2024, which is hereby incorporated by reference herein in its entirety.

1. An image forming apparatus comprising:
(i) a main assembly including
a first photosensitive drum rotatable about a first rotational axis extending in a first direction;
a first developing unit including a first developing container for accommodating first toner supplied to the first photosensitive drum and a first developing roller for carrying the first toner accommodated in the first developing container, the first toner being black toner;
a second photosensitive drum rotatable about a second rotational axis extending in the first direction; and
a second developing unit including a second developing container for accommodating second toner supplied to the second photosensitive drum and different in color from the first toner and a second developing roller for carrying the second toner accommodated in the second developing container, the second developing unit is aligned with the first developing unit in a second direction perpendicular to the first direction;
(ii) a first cartridge detachably mountable to the main assembly and accommodating the first toner, the first cartridge being provided with a first discharge opening for permitting discharge of the first toner toward the first developing container and being provided in one end portion of the image forming apparatus with respect to the second direction; and
(iii) a second cartridge detachably mountable to the main assembly and accommodating the second toner, the second cartridge being provided with a second discharge opening for permitting discharge of the second toner toward the second developing container and being provided with in the one end portion of the image forming apparatus with respect to the second direction,
wherein in a case where one end portion and the other end portion of the image forming apparatus with respect to the first direction are a first end portion and a second end portion, respectively,
the first cartridge of which longitudinal direction is the first direction and is disposed with respect to the first direction so that one end portion thereof is positioned on a side of the first end portion of the image forming apparatus and so that the other end portion thereof is positioned on a side of the second end portion of the image forming apparatus,
wherein the first discharge opening is provided in the end portion of the first cartridge on either one of the side of the first end portion and the side of the second end portion of the image forming apparatus,
wherein the second cartridge is disposed with respect to the first direction in a position closer to the first end portion than to the second end portion of the image forming apparatus,
wherein the second discharge opening is provided in an end portion of the second cartridge on a side of the first end portion of the image forming apparatus, and
wherein in a case where the second cartridge is viewed in a third direction perpendicular to both the first direction and the second direction, the second cartridge is disposed so that at least a part thereof overlaps with the first cartridge.

2. The image forming apparatus according to claim 1, wherein with respect to the first direction, the first cartridge includes a first region which is positioned on the side of the first end portion of the image forming apparatus and of which width in the third direction is a first width, and includes
a second region which is positioned on the side of the second end portion of the image forming apparatus and of which width in the third direction is a second width wider than the first width, and
wherein the second cartridge is disposed so that at least a part thereof overlaps with the first region as viewed in the third direction, and is disposed so that at least a part thereof overlaps with the second region as viewed in the first direction.

3. The image forming apparatus according to claim 1, wherein the first discharge opening is provided in the end portion of the first cartridge on the side of the second end portion of the image forming apparatus.

4. The image forming apparatus according to claim 1, further comprising a laser scanner,
wherein as viewed in the second direction, the first discharge opening and the second discharge opening are provided so as not to overlap with an optical path of laser light from the laser scanner toward the first photosensitive drum and an optical path of laser light from the laser scanner toward the second photosensitive drum, respectively.

5. The image forming apparatus according to claim 4, further comprising:
a first path through which the first toner discharged through the first discharge opening and moved toward the first developing container passes; and
a second path through which the second toner discharged through the second discharge opening and moved toward the second developing container passes,
wherein as viewed in the second direction, an end portion of the first path on the side of the first discharge opening and an end portion of the second path on the side of the second discharge opening are disposed so as not to overlap with the optical path of the laser light from the laser scanner toward the first photosensitive drum and the optical path of the laser light from the laser scanner toward the second photosensitive drum, respectively.

6. The image forming apparatus according to claim 1, wherein an accommodating volume of the first toner in the first cartridge is larger than an accommodating volume of the second toner in the second cartridge.

7. The image forming apparatus according to claim 1, wherein the first cartridge is provided with a first air receiving port through which air is received,
wherein the second cartridge is provided with a second air receiving port through which the air is received, and
wherein the main assembly includes
a first pump for sending the air to the first cartridge through the first air receiving port;
a second pump for sending the air to the second cartridge through the second air receiving port;
a first path through which the first toner discharged through the first discharge opening by the air received through the first air receiving port and moved toward the first developing container passes; and
a second path through which the second toner discharged through the second discharge opening by the air received through the second air receiving port and moved toward the second developing container passes.

8. The image forming apparatus according to claim 2, wherein the main assembly includes a third photosensitive drum rotatable about a third rotational axis extending in the first direction, a third developing unit including a third developing container for accommodating third toner supplied to the third photosensitive drum and different in color from the first toner and a third developing roller for carrying the third toner accommodated in the third developing container, a fourth photosensitive drum rotatable about a fourth rotational axis extending in the first direction, and a fourth developing unit including a fourth developing container for accommodating fourth toner supplied to the fourth photosensitive drum and different in color from the first toner and a fourth developing roller for carrying the fourth toner accommodated in the fourth developing container,
wherein the image forming apparatus further comprises
a third cartridge detachably mountable to the main assembly and accommodating the third toner, the third cartridge being provided with a third discharge opening for permitting discharge of the third toner toward the third developing container, and
a fourth cartridge detachably mountable to the main assembly and accommodating the fourth toner, the fourth cartridge being provided with a fourth discharge opening for permitting discharge of the fourth toner toward the fourth developing container,
wherein the first developing unit, the second developing unit, the third developing unit, and the fourth developing unit are disposed so as to be aligned in the second direction,
wherein the third cartridge and the fourth cartridge are disposed in the one end portion of the image forming apparatus with respect to the second direction,
wherein with respect to the first direction, the third cartridge is disposed in a position closer to the first end portion than to the second end portion of the image forming apparatus,
wherein the third discharge opening is provided in an end portion of the third cartridge on a side of the first end portion of the image forming apparatus,
wherein with respect to the first direction, the fourth cartridge is disposed in a position closer to the second end portion than to the first end portion of the image forming apparatus,
wherein the fourth discharge opening is provided in an end portion of the fourth cartridge on a side of the second end portion of the image forming apparatus,
wherein as viewed in the third direction, the third cartridge is disposed so that at least a part thereof overlaps with the first region, and
wherein as viewed in the third direction, the fourth cartridge is disposed so that at least a part thereof overlaps with the second region.

9. The image forming apparatus according to claim 8, wherein as viewed in the first direction, the fourth cartridge is disposed so that at least a part thereof overlaps with the third cartridge.

10. The image forming apparatus according to claim 2, wherein the main assembly includes a third photosensitive drum rotatable about a third rotational axis extending in the first direction, a developing unit including a third developing container for accommodating third toner supplied to the third photosensitive drum and different in color from the first toner and a third developing roller for carrying the third toner accommodated in the third developing container, a fourth photosensitive drum rotatable about a fourth rotational axis extending in the first direction, and a fourth developing unit including a fourth developing container for accommodating fourth toner supplied to the fourth photosensitive drum and different in color from the first toner and a fourth developing roller for carrying the fourth toner accommodated in the fourth developing container,
wherein the image forming apparatus further comprises
a third cartridge detachably mountable to the main assembly and accommodating the third toner, the third cartridge being provided with a third discharge opening for permitting discharge of the third toner toward the third developing container, and
a fourth cartridge detachably mountable to the main assembly and accommodating the fourth toner, the fourth cartridge being provided with a fourth discharge opening for permitting discharge of the fourth toner toward the fourth developing container,
wherein the first developing unit, the second developing unit, the third developing unit, and the fourth developing unit are disposed so as to be aligned in the second direction,
wherein the third cartridge and the fourth cartridge are disposed in the one end portion of the image forming apparatus with respect to the second direction,
wherein with respect to the first direction, the third cartridge is disposed in a position closer to the first end portion than to the second end portion of the image forming apparatus,
wherein the third discharge opening is provided in an end portion of the third cartridge on a side of the first end portion of the image forming apparatus,
wherein with respect to the first direction, the fourth cartridge is disposed in a position closer to the first end portion than to the second end portion of the image forming apparatus,
wherein the fourth discharge opening is provided in an end portion of the fourth cartridge on a side of the first end portion of the image forming apparatus,
wherein as viewed in the third direction, the third cartridge is disposed so that at least a part thereof overlaps with the first region, and as viewed in the first direction, the third cartridge is disposed so that at least a part thereof overlaps with the second region, and
wherein as viewed in the third direction, the fourth cartridge is disposed so that at least a part thereof overlaps with the first region, and as viewed in the first direction, the fourth cartridge is disposed so that at least a part thereof overlaps with the second region.

11. The image forming apparatus according to claim 8, further comprising a laser scanner,
wherein as viewed in the second direction, the first discharge opening, the second discharge opening, the third discharge opening, and the fourth discharge opening are provided so as not to overlap with optical paths of laser light from the laser scanner toward the first photosensitive drum, the second photosensitive drum, the third photosensitive drum, and the fourth photosensitive drum, respectively.

12. The image forming apparatus according to claim 11, further comprising:
a first path through which the first toner discharged through the first discharge opening and moved toward the first developing container passes;
a second path through which the second toner discharged through the second discharge opening and moved toward the second developing container passes;
a third path through which the third toner discharged through the third discharge opening and moved toward the third developing container passes; and
a fourth path through which the fourth toner discharged through the fourth discharge opening and moved toward the fourth developing container passes,
wherein as viewed in the second direction, an end portion of the first path on the side of the first discharge opening, an end portion of the second path on the side of the second discharge opening, an end portion of the third path on the side of the third discharge opening, and an end portion of the fourth path on the side of the fourth discharge opening are disposed so as not to overlap with the optical paths of the laser light from the laser scanner toward the first photosensitive drum, the second photosensitive drum, the third photosensitive drum, and the fourth photosensitive drum, respectively.

13. The image forming apparatus according to claim 8, wherein an accommodating volume of the first toner in the first cartridge is larger than each of accommodating volumes of the second toner in the second cartridge, the third toner in the third cartridge, and the fourth toner in the fourth cartridge.

14. The image forming apparatus according to claim 8, wherein the first cartridge is provided with a first air receiving port through which air is received,
wherein the second cartridge is provided with a second air receiving port through which the air is received,
wherein the third cartridge is provided with a third air receiving port through which the air is received,
wherein the fourth cartridge is provided with a fourth air receiving port through which the air is received, and
wherein the main assembly includes
a first pump for sending the air to the first cartridge through the first air receiving port;
a second pump for sending the air to the second cartridge through the second air receiving port;
a third pump for sending the air to the third cartridge through the third air receiving port;
a fourth pump for sending the air to the fourth cartridge through the fourth air receiving port;
a first path through which the first toner discharged through the first discharge opening by the air received through the first air receiving port and moved toward the first developing container passes;
a second path through which the second toner discharged through the second discharge opening by the air received through the second air receiving port and moved toward the second developing container passes;
a third path through which the third toner discharged through the third discharge opening by the air received through the third air receiving port and moved toward the third developing container passes; and
a fourth path through which the fourth toner discharged through the fourth discharge opening by the air received through the fourth air receiving port and moved toward the fourth developing container passes.
